(19) United States
(12) Patent Application Publication
(10) Pub. No.: US 2025/0182443 A1
(43) Pub. Date: Jun. 5, 2025

(54) IMAGE ANALYSIS BASED ON ADAPTIVE WEIGHTING OF TEMPLATE CONTOURS

(71) Applicant: ASML NETHERLANDS B.V., Veldhoven (NL)

(72) Inventor: Jiyou FU, San Jose, CA (US)

(73) Assignee: ASML NETHERLANDS B.V., Veldhoven (NL)

(21) Appl. No.: 18/837,576

(22) PCT Filed: Feb. 17, 2023
(86) PCT No.: PCT/EP2023/054118

§ 371 Date: Aug. 9, 2024

Related U.S. Application Data
(60) Provisional application No. 63/315,277, filed on Mar. 1, 2022.

(51) Int. Cl. G06V 10/75; G06T 7/00; G06V 10/74

(52) U.S. Cl. CPC G06V 10/751; G06T 7/001; G06V 10/752; G06V 10/761; G06T 2207/10061; G06T 2207/30148

(57) ABSTRACT

A method of characterizing an image. The method includes accessing a template contour that corresponds to a set of contour points extracted from the image. The method includes comparing the template contour and the extracted contour points based on a plurality of distances between locations on the template contour and the extracted contour points. The plurality of distances is weighted based on the locations on the template contour and overlap of the locations on the template contour with a blocking structure in the image. The method includes determining, based on the comparison, a matching geometry and/or a matching position of the template contour with the extracted contour points from the image.

### CROSS-REFERENCE TO RELATED APPLICATIONS

This application claims priority of U.S. application 63/315,277 which was filed on Mar. 1, 2022 and which is incorporated herein in its entirety by reference.

### TECHNICAL FIELD

The present disclosure relates generally to image analysis associated with metrology and inspection applications.

### BACKGROUND

A lithographic projection apparatus can be used, for example, in the manufacture of integrated circuits (ICs). A patterning device (e.g., a mask) may include or provide a pattern corresponding to an individual layer of the IC (“design layout”), and this pattern can be transferred onto a target portion (e.g. comprising one or more dies) on a substrate (e.g., silicon wafer) that has been coated with a layer of radiation-sensitive material (“resist”), by methods such as irradiating the target portion through the pattern on the patterning device. In general, a single substrate contains a plurality of adjacent target portions to which the pattern is transferred successively by the lithographic projection apparatus, one target portion at a time. In one type of lithographic projection apparatus, the pattern on the entire patterning device is transferred onto one target portion in one operation. Such an apparatus is commonly referred to as a stepper. In an alternative apparatus, commonly referred to as a step-and-scan apparatus, a projection beam scans over the patterning device in a given reference direction (the “scanning” direction) while synchronously moving the substrate parallel or anti-parallel to this reference direction. Different portions of the pattern on the patterning device are transferred to one target portion progressively. Since, in general, the lithographic projection apparatus will have a reduction ratio M (e.g., 4), the speed F at which the substrate is moved will be 1/M times that at which the projection beam scans the patterning device. More information with regard to lithographic devices can be found in, for example, U.S. Pat. No. 6,046,792, incorporated herein by reference.

Prior to transferring the pattern from the patterning device to the substrate, the substrate may undergo various procedures, such as priming, resist coating and a soft bake. After exposure, the substrate may be subjected to other procedures (“post-exposure procedures”), such as a post-exposure bake (PEB), development, a hard bake and measurement/inspection of the transferred pattern. This array of procedures is used as a basis to make an individual layer of a device, e.g., an IC. The substrate may then undergo various processes such as etching, ion-implantation (doping), metallization, oxidation, chemo-mechanical polishing, etc., all intended to finish the individual layer of the device. If several layers are required in the device, then the whole procedure, or a variant thereof, is repeated for each layer. Eventually, a device will be present in each target portion on the substrate. These devices are then separated from one another by a technique such as dicing or sawing, such that the individual devices can be mounted on a carrier, connected to pins, etc.

Manufacturing devices, such as semiconductor devices, typically involves processing a substrate (e.g., a semiconductor wafer) using a number of fabrication processes to form various features and multiple layers of the devices. Such layers and features are typically manufactured and processed using, e.g., deposition, lithography, etch, chemical-mechanical polishing, and ion implantation. Multiple devices may be fabricated on a plurality of dies on a substrate and then separated into individual devices. This device manufacturing process may be considered a patterning process. A patterning process involves a patterning step, such as optical and/or nanoimprint lithography using a patterning device in a lithographic apparatus, to transfer a pattern on the patterning device to a substrate and typically, but optionally, involves one or more related pattern processing steps, such as resist development by a development apparatus, baking of the substrate using a bake tool, etching using the pattern using an etch apparatus, etc.

Lithography is a central step in the manufacturing of device such as ICs, where patterns formed on substrates define functional elements of the devices, such as microprocessors, memory chips, etc. Similar lithographic techniques are also used in the formation of flat panel displays, micro-electromechanical systems (MEMS) and other devices.

As semiconductor manufacturing processes continue to advance, the dimensions of functional elements have continually been reduced. At the same time, the number of functional elements, such as transistors, per device has been steadily increasing, following a trend commonly referred to as “Moore's law.” At the current state of technology, layers of devices are manufactured using lithographic projection apparatuses that project a design layout onto a substrate using illumination from a deep-ultraviolet illumination source, creating individual functional elements having dimensions well below 100 nm, i.e., less than half the wavelength of the radiation from the illumination source (e.g., a 193 nm illumination source).

This process in which features with dimensions smaller than the classical resolution limit of a lithographic projection apparatus are printed, is commonly known as low-k1 lithography, according to the resolution formula CD=k1×λ/NA, where 2 is the wavelength of radiation employed (currently in most cases 248 nm or 193 nm), NA is the numerical aperture of projection optics in the lithographic projection apparatus, CD is the “critical dimension”—generally the smallest feature size printed—and k1 is an empirical resolution factor. In general, the smaller k1 the more difficult it becomes to reproduce a pattern on the substrate that resembles the shape and dimensions planned by a designer in order to achieve particular electrical functionality and performance. To overcome these difficulties, sophisticated fine-tuning steps are applied to the lithographic projection apparatus, the design layout, or the patterning device. These include, for example, but not limited to, optimization of NA and optical coherence settings, customized illumination schemes, use of phase shifting patterning devices, optical proximity correction (OPC, sometimes also referred to as “optical and process correction”) in the design layout, source mask optimization (SMO), or other methods generally defined as “resolution enhancement techniques” (RET).

In manufacturing processes of integrated circuits (ICs), unfinished or finished circuit components are inspected to ensure that they are manufactured according to design and are free of defects. Inspection systems utilizing optical microscopes or charged particle (e.g., electron) beam microscopes, such as a scanning electron microscope (SEM) can be employed. As the physical sizes of IC components continue to shrink, and their structures continue to become more complex, accuracy and throughput in defect detection and inspection become more important.

### SUMMARY

The present systems and methods can be used for characterizing features of a scanning electron microscope image and/or other images for metrology or inspection applications. In one embodiment, the systems and methods comprise shape fitting with template contour sliding and adaptive weighting, for example, to find the matching location or shape between the template and a test image. A template contour for a group of features of an arbitrary shape is progressively moved (e.g., slid) across a set of contour points extracted from an image. At individual template contour positions, and along a normal direction at each template contour location (e.g., an edge placement (EP) gauge line), a distance (dⱼ) between the template contour and an extracted contour point is measured. Each dⱼ can be associated with a weight (Wⱼ). For example, the weight is dependent on whether the point is blocked by a different feature in the image or is in a region of interest, where the different feature can be on the same process layer or a different layer. A best matching position of the template contour, and/or a best matching shape of the template contour, with the image, can be found by optimizing a similarity score that is determined based on a weighted sum of the distances.

A method of characterizing features of an image is described. The method comprises accessing a template contour that corresponds to a set of contour points extracted from the image; and comparing the template contour and the extracted contour points based on a plurality of distances between locations on the template contour and the extracted contour points. The plurality of distances is weighted based on overlap of the locations on the template contour with a blocking structure in the image. Based on the comparison, a matching geometry and/or a matching position of the template contour with the extracted contour points from the image is determined.

In some embodiments, the plurality of distances is further weighted based on the locations on the template contour.

In some embodiments, determining the matching position comprises placing the template contour in various locations on the image, and selecting the matching position from among the various locations based on the comparison. In some embodiments, determining the matching geometry comprises generating various geometries of the template contour on the image, and selecting the matching geometry from among the various geometries based on the comparison.

In some embodiments, the comparing comprises determining similarity between the template contour and the extracted contour points based on the weighted distances.

In some embodiments, the similarity is determined based on a weighted sum of the plurality of distances. In some embodiments, the weighted sum is determined based on the overlap of the locations on the template contour with the blocking structure in the image.

In some embodiments, the plurality of distances is further weighted based on a weight map associated with the template contour. In some embodiments, the plurality of distances is further weighted based on a weight map associated with the blocking structure.

In some embodiments, a total weight for each of the plurality of distances is determined by multiplying a weight associated with the template contour by a corresponding weight associated with the blocking structure.

In some embodiments, weights change based on positioning of the template contour on the image.

In some embodiments, the comparing comprises: accessing blocking structure weights for locations on the blocking structure; and determining a total weight for each location on the template contour based on the blocking structure weights and weights associated with corresponding locations on the contour that overlap with the blocking structure.

In some embodiments, the comparing comprises determining a coarse similarity score based on the total weights.

In some embodiments, the method further comprises repeating the determining the coarse similarity score for multiple geometries or positions of the template contour relative to the extracted contour points to determine an optimized course position of the template contour relative to the extracted contour points.

In some embodiments, the blocking structure weights follow a step function or a sigmoid function or user defined function.

In some embodiments, the blocking structure weights are determined based on an intensity profile of pixels in the image that form the blocking structure.

In some embodiments, the comparing comprises: adjusting weights associated with corresponding locations on the contour that overlap with the blocking structure; and determining a total weight for each location on the contour multiplying blocking structure weights by the adjusted weights associated with corresponding locations on the contour that overlap with the blocking structure.

In some embodiments, the comparing further comprises: determining a first fine similarity score based on a weighted sum of the plurality of distances multiplied by the total weights; and determining a second fine similarity score based on a weighted sum of the plurality of distances multiplied by the total weights only for unblocked locations on the contour that do not overlap with the blocking structure.

In some embodiments, the comparing further comprises repeating the adjusting and the determining the first and second fine similarity for multiple geometries or positions of the template contour relative to the extracted contour points to determine an optimized fine position of the template contour relative to the extracted contour points.

In some embodiments, adjusting the weights associated with the corresponding locations on the template contour that overlap with the blocking structure comprises: updating a weight for a given position on the template contour based on at least one of pixel values of the image, a location of the blocking structure in the image relative to the template contour, a previously identified structure located on the image, a location of the template contour, a relative position of the template contour with respect to the extracted contour points, or a combination thereof.

In some embodiments, total weights for unblocked locations on the contour that do not overlap with the blocking structure are defined by a threshold on the weights associated with the corresponding locations on the contour.

In some embodiments, determining a matching geometry or a matching position of the template contour relative to the extracted contour points comprises translation, scaling, and/or rotation of the template contour relative to the extracted contour points.

In some embodiments, scaling comprises: determining corresponding contour locations for each template contour whose scale factor is not equal to one using a same EP gauge line direction as a template contour whose scale factor is equal to one; determining similarities for each scale factor in the scale factor range; and adjusting the geometry or position of the template contour relative to the extracted contour points based on the similarities for each scale factor in the scale factor range.

In some embodiments, the EP gauge line locations on the template contour are user defined, determined based on a curvature of the template contour, and/or determined based on key locations of interest on the template contour.

In some embodiments, the plurality of distances correspond to edge placement (EP) gauge lines, and wherein an EP gauge line is normal to the template contour.

In some embodiments, the method further comprises determining a metrology metric (e.g., overlay, CD, EPE, etc.) based on an adjusted geometry or position of the template contour relative to the extracted contour points.

In some embodiments, the method further comprises determining overlay between a first test feature and second test feature based on an adjusted geometry or position of the template contour relative to the extracted contour points.

In some embodiments, weights associated with corresponding locations on the contour are defined by a contour weight map.

In some embodiments, the template contour is determined based one or more acquired or synthetic images of a measurement structure using contour extraction techniques.

In some embodiments, the template contour is determined by selecting a first feature of a synthetic image of the measurement structure and generating the template contour based at least in part on the first feature.

In some embodiments, the template contour is determined based on one or more pixel values for one or more acquired or synthetic images.

In some embodiments, the template contour is determined based on one or more reference shapes from one or more design files associated with the image.

In some embodiments, the blocking structure comprises a portion of the image that represents a physical feature in a layer of a semiconductor structure, the physical feature blocking a view of a portion of a feature of interest in the image because of its location in the layer of the semiconductor structure relative to the feature of interest, the feature of interest being a feature from which the contour points are extracted.

In some embodiments, the comparing comprises two steps, for example a coarse determination step, and a fine determination step.

According to another embodiment, there is provided a non-transitory computer readable medium having instructions thereon, the instructions when executed by a computer causing the computer to perform any of the method operations described above.

According to another embodiment, there is provided a system for characterizing features of an image. The system comprises one or more processors configured to execute any of the method operations described above.

According to another embodiment, there is provided a non-transitory computer readable medium having instructions thereon, the instructions when executed by a computer causing the computer to perform a method of deriving metrology information by characterizing features in an image. The method comprises accessing a template contour that corresponds to a set of contour points extracted from the image; and comparing, by determining a similarity between, the template contour and the extracted contour points based on a plurality of distances between locations on the template contour and the extracted contour points. The plurality of distances is adaptively weighted based on the locations on the template contour and whether the locations on the template contour overlap with blocking structures in the image. Comparing comprises: accessing blocking structure weights for locations on the blocking structures; multiplying the blocking structure weights by weights associated with corresponding locations on the contour that overlap with the blocking structures to determine a total weight for each location on the contour; determining a coarse similarity score based on a weighted sum of the plurality of distances multiplied by the total weights; and repeating the multiplying and determining the coarse similarity score operations for multiple geometries or positions of the template contour relative to the extracted contour points to determine an optimized coarse position of the template contour relative to the extracted contour points; adjusting the weights associated with the corresponding locations on the contour that overlap with the blocking structures; multiplying the blocking structure weights by the adjusted weights associated with corresponding locations on the contour that overlap with the blocking structures to determine a total weight for each location on the contour; determining a first fine similarity score based on a weighted sum of the plurality of distances multiplied by the total weights; determining a second fine similarity score based on a weighted sum of the plurality of distances multiplied by the total weights only for unblocked locations on the contour that do not overlap with the blocking structures; and repeating the adjusting, the multiplying, and the determining the first and second fine similarity operations for multiple geometries or positions of the template contour relative to the extracted contour points to determine an optimized fine position of the template contour relative to the extracted contour points. The method comprises determining, based on the comparing, a matching geometry or a matching position of the template contour with the extracted contour points from the image.

### BRIEF DESCRIPTION OF THE DRAWINGS

The accompanying drawings, which are incorporated in and constitute a part of the specification, illustrate one or more embodiments and, together with the description, explain these embodiments. Embodiments of the invention will now be described, by way of example only, with reference to the accompanying schematic drawings in which corresponding reference symbols indicate corresponding parts, and in which:

FIG. 1A depicts a schematic overview of a lithographic apparatus, according to an embodiment.

FIG. 1B depicts a schematic overview of a lithographic cell, according to an embodiment.

FIG. 2 depicts a schematic representation of holistic lithography, representing a cooperation between three technologies to optimize semiconductor manufacturing, according to an embodiment.

FIG. 3A schematically depicts an embodiment of a charged particle (e.g., an electron beam) inspection apparatus, according to an embodiment.

FIG. 3B schematically illustrates an embodiment of a single electron beam inspection apparatus, according to an embodiment.

FIG. 3C schematically illustrates an embodiment of a multi electron beam inspection apparatus, according to an embodiment.

FIG. 4 illustrates a method of characterizing features of an image, according to an embodiment.

FIG. 5 illustrates a scanning electron microscope (SEM) image with extracted contour points, a template contour, and blocking structures, according to an embodiment.

FIG. 6 illustrates a single template contour and one example distance between a location on the template contour and an extracted contour point (that is part of the contour points shown in FIG. 5), according to an embodiment.

FIG. 7 illustrates a template contour, a blocking structure, and corresponding locations of high weight and low weight along a template contour, according to an embodiment.

FIG. 8 illustrates example blocking structure weights that follow a sigmoid function relative to a blocking structure, according to an embodiment.

FIG. 9A illustrates how an example template contour is formed by portions of a rectangle, and portions of an ellipse, that each have their own equations, respectively, with geometry parameters that describe portions of the shape of the template contour, according to an embodiment.

FIG. 9B illustrates an arbitrary shape template contour, according to an embodiment.

FIG. 10 illustrates an example of scaling a template contour, according to an embodiment.

FIG. 11 is a block diagram of an example computer system, according to an embodiment.

### DETAILED DESCRIPTION

Shape fitting and/or template matching can be applied to determine a size and/or position of features in a semiconductor or other structure during fabrication, where feature location, shape, size, and alignment knowledge is useful for process control, quality assessment, etc. Shape fitting and/or template matching for features of multiple layers can be used to determine overlay (e.g., layer-to-layer shift) and/or other metrics, for example. Shape fitting and/or template matching can also be used to determine distances between features and contours of features, which may be in the same or different layers, and can be used to determine overlay (OVL), edge placement (EP), edge placement error (EPE), and/or critical dimension (CD) with various types of metrologies.

Shape fitting and/or template matching is often performed on scanning electron microscope (SEM) image features. Template matching is often performed by comparing image pixel grey level values between an image of interest and a template. However, shape fitting typically can only fit an SEM image feature (e.g., a contact hole) using a circle or an ellipse, not an arbitrary shape. In addition, template matching requires that a template and images of interest have similar pixel grey levels and similar feature shapes. If SEM images have a large grey level variation, for example, a position accuracy from template matching will be degraded.

Advantageously, the present systems and methods comprise shape fitting with template contour sliding and adaptive weighting. A template contour for a group of features of an arbitrary shape is accessed and/or otherwise determined. The template contour is progressively moved (e.g., slid) across a contour, e.g., represented by a set of extracted contour points. At individual template contour positions, and along a certain direction at each template contour location, a distance (dⱼ) between the template contour and an extracted contour point is measured. The direction can be a normal direction at each contour location (e.g., EP gauge line). Each dⱼ is associated with a weight (Wⱼ) dependent on whether the point is blocked by a different feature in the image or is in a region of interest. A best matching position of the template contour, and/or a best matching shape of the template contour, with the image, can be found by optimizing a similarity score that is determined based on a weighted sum of the distances.

Embodiments of the present disclosure are described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Although specific reference may be made in this text to the manufacture of ICs, it should be explicitly understood that the description herein has many other possible applications. For example, it may be employed in the manufacture of integrated optical systems, guidance and detection patterns for magnetic domain memories, liquid-crystal display panels, thin-film magnetic heads, etc. The skilled artisan will appreciate that, in the context of such alternative applications, any use of the terms “reticle”, “wafer” or “die” in this text should be considered as interchangeable with the more general terms “mask”, “substrate” and “target portion”, respectively.

In the present document, the terms “radiation” and “beam” are used to encompass all types of electromagnetic radiation, including ultraviolet radiation (e.g., with a wavelength of 365, 248, 193, 157 or 126 nm) and EUV (extreme ultra-violet radiation, e.g., having a wavelength in the range of about 5-100 nm).

A (e.g., semiconductor) patterning device can comprise, or can form, one or more patterns. The pattern can be generated utilizing CAD (computer-aided design) programs, based on a pattern or design layout, this process often being referred to as EDA (electronic design automation). Most CAD programs follow a set of predetermined design rules in order to create functional design layouts/patterning devices. These rules are set by processing and design limitations. For example, design rules define the space tolerance between devices (such as gates, capacitors, etc.) or interconnect lines, so as to ensure that the devices or lines do not interact with one another in an undesirable way. The design rules may include and/or specify specific parameters, limits on and/or ranges for parameters, and/or other information. One or more of the design rule limitations and/or parameters may be referred to as a “critical dimension” (CD). A critical dimension of a device can be defined as the smallest width of a line or hole or the smallest space between two lines or two holes, or other features. Thus, the CD determines the overall size and density of the designed device. One of the goals in device fabrication is to faithfully reproduce the original design intent on the substrate (via the patterning device).

The term “mask” or “patterning device” as employed in this text may be broadly interpreted as referring to a generic semiconductor patterning device that can be used to endow an incoming radiation beam with a patterned cross-section, corresponding to a pattern that is to be created in a target portion of the substrate. Besides the classic mask (transmissive or reflective; binary, phase-shifting, hybrid, etc.), examples of other such patterning devices include a programmable mirror array and a programmable LCD array.

As used herein, the term “patterning process” generally means a process that creates an etched substrate by the application of specified patterns of light as part of a lithography process. However, “patterning process” can also include (e.g., plasma) etching, as many of the features described herein can provide benefits to forming printed patterns using etch (e.g., plasma) processing.

As used herein, the term “pattern” means an idealized pattern that is to be etched on a substrate (e.g., wafer)—e.g., based on the design layout described above. A pattern may comprise, for example, various shape(s), arrangement(s) of features, contour(s), etc.

As used herein, a “printed pattern” means the physical pattern on a substrate that was etched based on a target pattern. The printed pattern can include, for example, troughs, channels, depressions, edges, or other two- and three-dimensional features resulting from a lithography process.

As used herein, the term “calibrating” means to modify (e.g., improve or tune) and/or validate a model, an algorithm, and/or other components of a present system and/or method.

A patterning system may be a system comprising any or all of the components described above, plus other components configured to performing any or all of the operations associated with these components. A patterning system may include a lithographic projection apparatus, a scanner, systems configured to apply and/or remove resist, etching systems, and/or other systems, for example.

As used herein, the term “diffraction” refers to the behavior of a beam of light or other electromagnetic radiation when encountering an aperture or series of apertures, including a periodic structure or grating. “Diffraction” can include both constructive and destructive interference, including scattering effects and interferometry. As used herein, a “grating” is a periodic structure, which can be one-dimensional (i.e., comprised of posts of dots), two-dimensional, or three-dimensional, and which causes optical interference, scattering, or diffraction. A “grating” can be a diffraction grating.

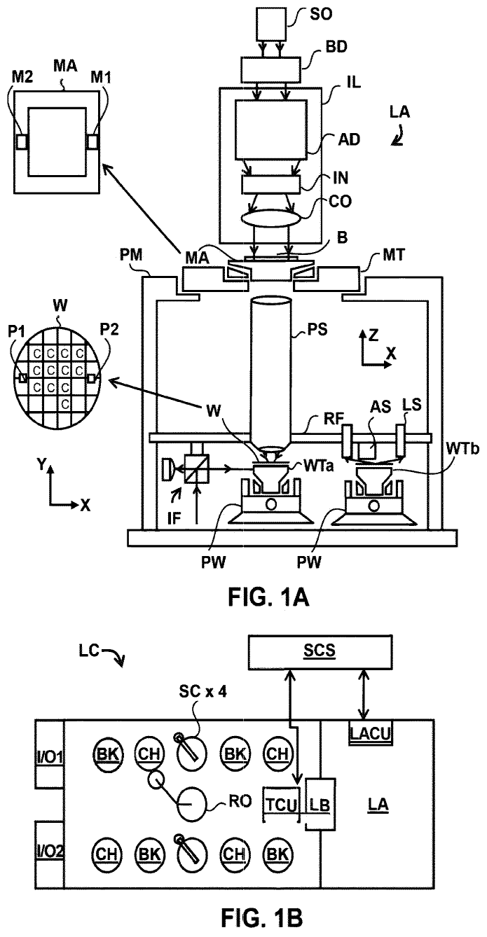

As a brief introduction, FIG. 1A schematically depicts a lithographic apparatus LA. LA may be used to produce a patterned substrate (e.g., wafer) as described. The patterned substrate may be inspected/measured by an SEM according to the shape fitting with template contour sliding and adaptive weighting described herein as part of a semiconductor manufacturing process, for example. The lithographic apparatus LA includes an illumination system (also referred to as illuminator) IL configured to condition a radiation beam B (e.g., UV radiation, DUV radiation or EUV radiation), a mask support (e.g., a mask table) T constructed to support a patterning device (e.g., a mask) MA and connected to a first positioner PM configured to accurately position the patterning device MA in accordance with certain parameters, a substrate support (e.g., a wafer table) WT configured to hold a substrate (e.g., a resist coated wafer) W and coupled to a second positioner PW configured to accurately position the substrate support in accordance with certain parameters, and a projection system (e.g., a refractive projection lens system) PS configured to project a pattern imparted to the radiation beam B by patterning device MA onto a target portion C (e.g., comprising one or more dies) of the substrate W.

In operation, the illumination system IL receives a radiation beam from a radiation source SO, e.g., via a beam delivery system BD. The illumination system IL may include various types of optical components, such as refractive, reflective, magnetic, electromagnetic, electrostatic, and/or other types of optical components, or any combination thereof, for directing, shaping, and/or controlling radiation. The illuminator IL may be used to condition the radiation beam B to have a desired spatial and angular intensity distribution in its cross section at a plane of the patterning device MA.

The term “projection system” PS used herein should be broadly interpreted as encompassing various types of projection system, including refractive, reflective, catadioptric, anamorphic, magnetic, electromagnetic and/or electrostatic optical systems, or any combination thereof, as appropriate for the exposure radiation being used, and/or for other factors such as the use of an immersion liquid or the use of a vacuum. Any use of the term “projection lens” herein may be considered as synonymous with the more general term “projection system” PS.

The lithographic apparatus LA may be of a type wherein at least a portion of the substrate may be covered by a liquid having a relatively high refractive index, e.g., water, so as to fill a space between the projection system PS and the substrate W—which is also referred to as immersion lithography. More information on immersion techniques is given in U.S. Pat. No. 6,952,253, which is incorporated herein by reference.

The lithographic apparatus LA may also be of a type having two or more substrate supports WT (also named “dual stage”). In such a “multiple stage” machine, the substrate supports WT may be used in parallel, and/or steps in preparation of a subsequent exposure of the substrate W may be carried out on the substrate W located on one of the substrate support WT while another substrate W on the other substrate support WT is being used for exposing a pattern on the other substrate W.

In addition to the substrate support WT, the lithographic apparatus LA may comprise a measurement stage. The measurement stage is arranged to hold a sensor and/or a cleaning device. The sensor may be arranged to measure a property of the projection system PS or a property of the radiation beam B. The measurement stage may hold multiple sensors. The cleaning device may be arranged to clean part of the lithographic apparatus, for example a part of the projection system PS or a part of a system that provides the immersion liquid. The measurement stage may move beneath the projection system PS when the substrate support WT is away from the projection system PS.

In operation, the radiation beam B is incident on the patterning device, e.g., mask, MA which is held on the mask support MT, and is patterned by the pattern (design layout) present on patterning device MA. Having traversed the mask MA, the radiation beam B passes through the projection system PS, which focuses the beam onto a target portion C of the substrate W. With the aid of the second positioner PW and a position measurement system IF, the substrate support WT can be moved accurately, e.g., so as to position different target portions C in the path of the radiation beam B at a focused and aligned position. Similarly, the first positioner PM and possibly another position sensor (which is not explicitly depicted in FIG. 1A) may be used to accurately position the patterning device MA with respect to the path of the radiation beam B. Patterning device MA and substrate W may be aligned using mask alignment marks M1, M2 and substrate alignment marks P1, P2. Although the substrate alignment marks P1, P2 as illustrated occupy dedicated target portions, they may be located in spaces between target portions. Substrate alignment marks P1, P2 are known as scribe-lane alignment marks when these are located between the target portions C.

FIG. 1B depicts a schematic overview of a lithographic cell LC. As shown in FIG. 1B the lithographic apparatus LA may form part of lithographic cell LC, also sometimes referred to as a lithocell or (litho) cluster, which often also includes apparatus to perform pre- and post-exposure processes on a substrate W. Conventionally, these include spin coaters SC configured to deposit resist layers, developers DE to develop exposed resist, chill plates CH and bake plates BK, e.g. for conditioning the temperature of substrates, W e.g., for conditioning solvents in the resist layers. A substrate handler, or robot, RO picks up substrates W from input/output ports I/O1, I/O2, moves them between the different process apparatus and delivers the substrates W to the loading bay LB of the lithographic apparatus LA. The devices in the lithocell, which are often also collectively referred to as the track, are typically under the control of a track control unit TCU that in itself may be controlled by a supervisory control system SCS, which may also control the lithographic apparatus LA, e.g., via lithography control unit LACU.

In order for the substrates W (FIG. 1A) exposed by the lithographic apparatus LA to be exposed correctly and consistently, it is desirable to inspect substrates to measure properties of patterned structures, such as overlay errors between subsequent layers, line thicknesses, critical dimensions (CD), etc. For this purpose, inspection tools (not shown) may be included in the lithocell LC. If errors are detected, adjustments, for example, may be made to exposures of subsequent substrates or to other processing steps that are to be performed on the substrates W, especially if the inspection is done before other substrates W of the same batch or lot are still to be exposed or processed.

An inspection apparatus, which may also be referred to as a metrology apparatus, is used to determine properties of the substrates W (FIG. 1A), and, in particular, how properties of different substrates W vary or how properties associated with different layers of the same substrate W vary from layer to layer. The inspection apparatus may alternatively be constructed to identify defects on the substrate W and may, for example, be part of the lithocell LC, or may be integrated into the lithographic apparatus LA, or may even be a stand-alone device. The inspection apparatus may measure the properties on a latent image (image in a resist layer after the exposure), or on a semi-latent image (image in a resist layer after a post-exposure bake step PEB), or on a developed resist image (in which the exposed or unexposed parts of the resist have been removed), or even on an etched image (after a pattern transfer step such as etching), for example.

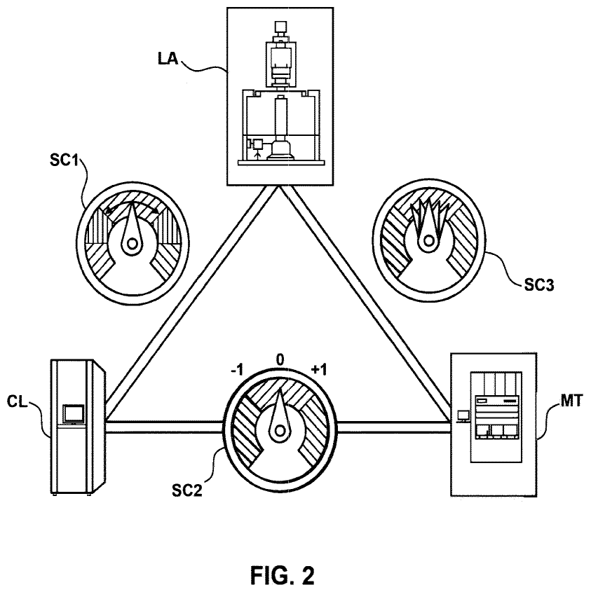

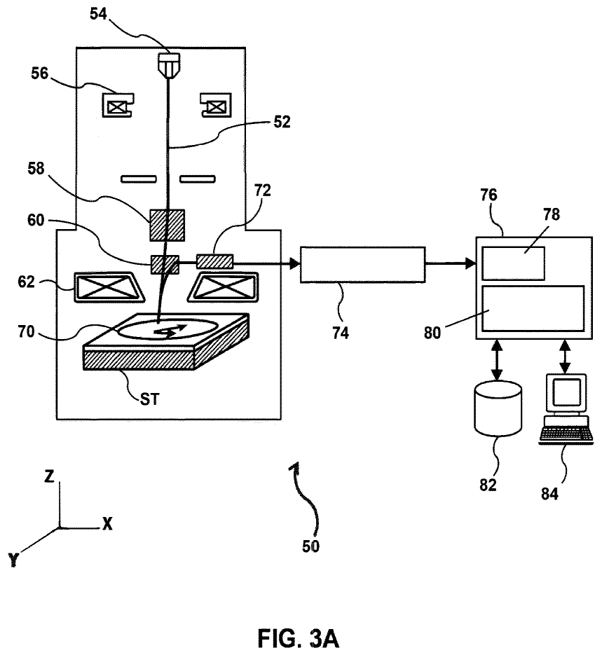

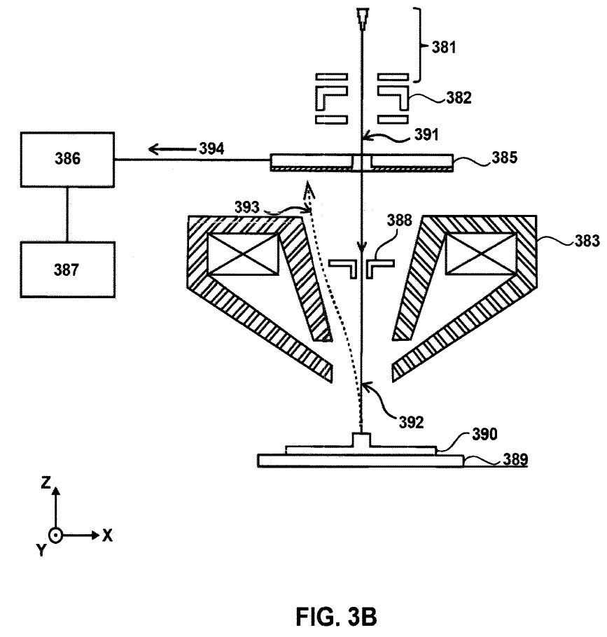

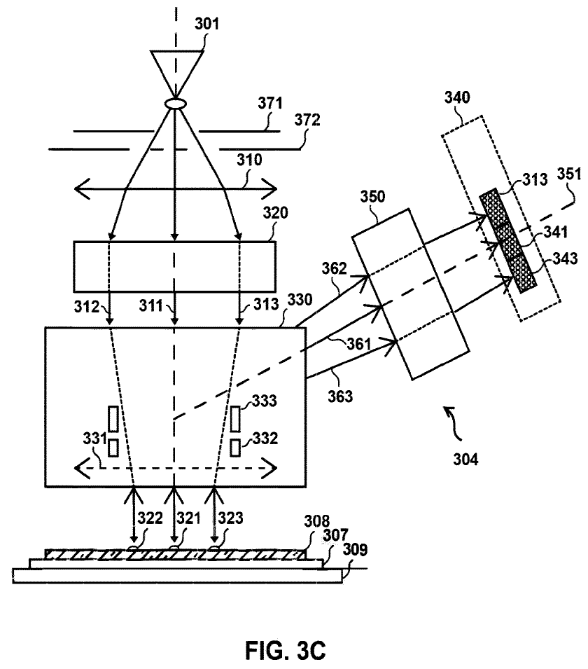

FIG. 2 depicts a schematic representation of holistic lithography, representing a cooperation between three technologies to optimize semiconductor manufacturing. Typically, the patterning process in lithographic apparatus LA is one of the most critical steps in the processing which requires high accuracy of dimensioning and placement of structures on the substrate W (FIG. 1A). To ensure this high accuracy, three systems (in this example) may be combined in a so called “holistic” control environment as schematically depicted in FIG. 3. One of these systems is the lithographic apparatus LA which is (virtually) connected to a metrology apparatus (e.g., a metrology tool) MT (a second system), and to a computer system CL (a third system). A “holistic” environment may be configured to optimize the cooperation between these three systems to enhance the overall process window and provide tight control loops to ensure that the patterning performed by the lithographic apparatus LA stays within a process window. The process window defines a range of process parameters (e.g., dose, focus, overlay) within which a specific manufacturing process yields a defined result (e.g., a functional semiconductor device)—typically within which the process parameters in the lithographic process or patterning process are allowed to vary.

The computer system CL may use (part of) the design layout to be patterned to predict which resolution enhancement techniques to use and to perform computational lithography simulations and calculations to determine which mask layout and lithographic apparatus settings achieve the largest overall process window of the patterning process (depicted in FIG. 2 by the double arrow in the first scale SC1). Typically, the resolution enhancement techniques are arranged to match the patterning possibilities of the lithographic apparatus LA. The computer system CL may also be used to detect where within the process window the lithographic apparatus LA is currently operating (e.g., using input from the metrology tool MT) to predict whether defects may be present due to, for example, sub-optimal processing (depicted in FIG. 2 by the arrow pointing “0” in the second scale SC2).

The metrology apparatus (tool) MT may provide input to the computer system CL to enable accurate simulations and predictions, and may provide feedback to the lithographic apparatus LA to identify possible drifts, e.g., in a calibration status of the lithographic apparatus LA (depicted in FIG. 2 by the multiple arrows in the third scale SC3).

In lithographic processes, it is desirable to make frequent measurements of the structures created, e.g., for process control and verification. Different types of metrology tools MT for making such measurements are known, including scanning electron microscopes or various forms of optical metrology tools, image based or scatterometery-based metrology tools, and/or other tools. Image analysis on images obtained from optical metrology tools and scanning electron microscopes (SEMs) can be used to measure various dimensions (e.g., CD, overlay, edge placement error (EPE) etc.) and detect defects for the structures. In some cases, a feature of one layer of the structure can obscure a feature of another or the same layer of the structure in an image. This can be the case when one layer is physically on top of another layer, or when one layer is electronically rich and therefore brighter than another layer in a scanning electron microscopy (SEM) image, for example. In cases where a feature of interest is partially obscured in an image, the location of the image can be determined based on techniques described herein.

Fabricated devices (e.g., patterned substrates) may be inspected at various points during manufacturing. FIG. 3A schematically depicts a generalized embodiment of an charged particle (electron beam) inspection apparatus (system) 50. In some embodiments, inspection apparatus 50 may be an electron beam or other charged particle inspection apparatus (e.g., the same as or similar to a scanning electron microscope (SEM)) that yields an image of a structure (e.g., some or all the structure of a device, such as an integrated circuit) exposed or transferred on a substrate. A primary electron beam 52 emitted from an electron source 54 is converged by condenser lens 56 and then passes through a beam deflector 58, an E×B deflector 60, and an objective lens 62 to irradiate a substrate 70 on a substrate table ST at a focus.

When the substrate 70 is irradiated with electron beam 52, secondary electrons are generated from the substrate 70. The secondary electrons are deflected by the E×B deflector 60 and detected by a secondary electron detector 72. A two-dimensional electron beam image can be obtained by detecting the electrons generated from the sample in synchronization with, e.g., two dimensional scanning of the electron beam by beam deflector 58 or with repetitive scanning of electron beam 52 by beam deflector 58 in an X or Y direction, together with continuous movement of the substrate 70 by the substrate table ST in the other of the X or Y direction. Thus, in some embodiments, the electron beam inspection apparatus has a field of view for the electron beam defined by the angular range into which the electron beam can be provided by the electron beam inspection apparatus (e.g., the angular range through which the deflector 60 can provide the electron beam 52). Thus, the spatial extent of the field of the view is the spatial extent to which the angular range of the electron beam can impinge on a surface (wherein the surface can be stationary or can move with respect to the field).

As shown in FIG. 3A, a signal detected by secondary electron detector 72 may be converted to a digital signal by an analog/digital (A/D) converter 74, and the digital signal may be sent to an image processing system 76. In some embodiments, the image processing system 76 may have memory 78 to store all or part of digital images for processing by a processing unit 80. The processing unit 80 (e.g., specially designed hardware or a combination of hardware and software or a computer readable medium comprising software) is configured to convert or process the digital images into datasets representative of the digital images. In some embodiments, the processing unit 80 is configured or programmed to cause execution of an operation (e.g., image analysis based on adaptive weighting of template contours) described herein. Further, image processing system 76 may have a storage medium 82 configured to store the digital images and corresponding datasets in a reference database. A display device 84 may be connected with the image processing system 76, so that an operator can conduct necessary operation of the equipment with the help of a graphical user interface.

FIG. 3B schematically illustrates an embodiment of a single beam charged particle inspection apparatus (system), such as an SEM. The apparatus is used to inspect a sample 390 (such as a patterned substrate) on a sample stage 389 and comprises a charged particle beam generator 381, a condenser lens module 399, a probe forming objective lens module 383, a charged particle beam deflection module 388, a secondary charged particle detector module 385, an image forming module 386, or other components. The charged particle beam generator 381 generates a primary charged particle beam 391. The condenser lens module 399 condenses the generated primary charged particle beam 391. The probe forming objective lens module 383 focuses the condensed primary charged particle beam into a charged particle beam probe 392. The charged particle beam deflection module 388 scans the formed charged particle beam probe 392 across the surface of an area of interest on the sample 390 secured on the sample stage 389. In some embodiments, the charged particle beam generator 381, the condenser lens module 383, and the probe forming objective lens module 383, or their equivalent designs, alternatives or any combination thereof, together form a charged particle beam probe generator which generates the scanning charged particle beam probe 392.

The secondary charged particle detector module 385 detects secondary charged particles 393 emitted from the sample surface (maybe also along with other reflected or scattered charged particles from the sample surface) upon being bombarded by the charged particle beam probe 392 to generate a secondary charged particle detection signal 394. The image forming module 386 (e.g., a computing device) is coupled with the secondary charged particle detector module 385 to receive the secondary charged particle detection signal 394 from the secondary charged particle detector module 385 and accordingly form at least one scanned image. In some embodiments, the secondary charged particle detector module 385 and image forming module 386, or their equivalent designs, alternatives or any combination thereof, together form an image forming apparatus which forms a scanned image from detected secondary charged particles emitted from sample 390 being bombarded by the charged particle beam probe 392.

In some embodiments, a monitoring module 387 is coupled to the image forming module 386 of the image forming apparatus to monitor, control, etc. the patterning process or derive a parameter for patterning process design, control, monitoring, etc. using the scanned image of the sample 390 received from image forming module 386. In some embodiments, the monitoring module 387 is configured or programmed to cause execution of an operation described herein. In some embodiments, the monitoring module 387 comprises a computing device. In some embodiments, the monitoring module 387 comprises a computer program configured to provide functionality described herein. In some embodiments, a probe spot size of the electron beam in the system of FIG. 3B is significantly larger compared to, e.g., a CD, such that the probe spot is large enough so that the inspection speed can be fast. However, the resolution may be lower because of the large probe spot.

FIG. 3C schematically illustrates an embodiment of a multi-electron beam inspection apparatus (e.g., SEM), according to an embodiment. FIG. 3C is a schematic diagram illustrating an exemplary electron beam tool 304 including a multi-beam inspection tool. It will be understood that the multi-beam electron beam tool is intended to be illustrative only and not to be limiting. The present disclosure can also work with a single charged-particle beam imaging system (e.g., as described above). As shown in FIG. 3C, electron beam tool 304 comprises an electron source 301 configured to generate a primary electron beam, a Coulomb aperture plate (or “gun aperture plate”) 371 configured to reduce Coulomb effect, a condenser lens 310 configured to focus primary electron beam, a source conversion unit 320 configured to form primary beamlets (e.g., primary beamlets 311, 312, and 313), a primary projection system 330, a motorized stage, and a sample holder 307 supported by the motorized stage to hold a wafer 308 to be inspected. Electron beam tool 304 may further comprise a secondary projection system 350 and an electron detection device 340. Primary projection system 330 may comprise an objective lens 331. Electron detection device 340 may comprise a plurality of detection elements 341, 342, and 343. A beam separator 333 and a deflection scanning unit 332 may be positioned inside primary projection system 330.

Electron source 301, Coulomb aperture plate 371, condenser lens 310, source conversion unit 320, beam separator 333, deflection scanning unit 332, and primary projection system 330 may be aligned with a primary optical axis of tool 304. Secondary projection system 350 and electron detection device 340 may be aligned with a secondary optical axis 351 of tool 304.

Controller 309 may be connected to various components, such as source conversion unit 320, electron detection device 340, primary projection system 330, or a motorized stage. In some embodiments, as explained in further details below, controller 309 may perform various image and signal processing functions. Controller 309 may also generate various control signals to control operations of one or more components of the charged particle beam inspection system.

Deflection scanning unit 332, in operation, is configured to deflect primary beamlets 311, 312, and 313 to scan probe spots 321, 322, and 323 across individual scanning areas in a section of the surface of wafer 308. In response to incidence of primary beamlets 311, 312, and 313 or probe spots 321, 322, and 323 on wafer 308, electrons emerge from wafer 308 and generate three secondary electron beams 361, 362, and 363. Each of secondary electron beams 361, 362, and 363 typically comprise secondary electrons (having electron energy≤50 eV) and backscattered electrons (having electron energy between 50e V and the landing energy of primary beamlets 311, 312, and 313). Beam separator 333 is configured to deflect secondary electron beams 361, 362, and 363 towards secondary projection system 350. Secondary projection system 350 subsequently focuses secondary electron beams 361, 362, and 363 onto detection elements 341, 342, and 343 of electron detection device 340. Detection elements 341, 342, and 343 are arranged to detect corresponding secondary electron beams 361, 362, and 363 and generate corresponding signals which are sent to controller 309 or a signal processing system (not shown), e.g., to construct images of the corresponding scanned areas of wafer 308.

In some embodiments, detection elements 341, 342, and 343 detect corresponding secondary electron beams 361, 362, and 363, respectively, and generate corresponding intensity signal outputs (not shown) to an image processing system (e.g., controller 309). In some embodiments, each detection elements 341, 342, and 343 may comprise one or more pixels. The intensity signal output of a detection element may be a sum of signals generated by all the pixels within the detection element.

In some embodiments, controller 309 may comprise an image processing system that includes an image acquirer (not shown) and a storage (not shown). The image acquirer may comprise one or more processors. For example, the image acquirer may comprise a computer, server, mainframe host, terminals, personal computer, any kind of mobile computing devices, and the like, or a combination thereof. The image acquirer may be communicatively coupled to electron detection device 340 of tool 304 through a medium such as an electrical conductor, optical fiber cable, portable storage media, IR, Bluetooth, internet, wireless network, wireless radio, among others, or a combination thereof. In some embodiments, the image acquirer may receive a signal from electron detection device 340 and may construct an image. The image acquirer may thus acquire images of wafer 308. The image acquirer may also perform various post-processing functions, such as generating contours, superimposing indicators on an acquired image, and the like. The image acquirer may be configured to perform adjustments of brightness and contrast, etc. of acquired images. In some embodiments, the storage may be a storage medium such as a hard disk, flash drive, cloud storage, random access memory (RAM), other types of computer readable memory, and the like. The storage may be coupled with the image acquirer and may be used for saving scanned raw image data as original images, and post-processed images.

In some embodiments, the image acquirer may acquire one or more images of a sample based on one or more imaging signals received from electron detection device 340. An imaging signal may correspond to a scanning operation for conducting charged particle imaging. An acquired image may be a single image comprising a plurality of imaging areas or may involve multiple images. The single image may be stored in the storage. The single image may be an original image that may be divided into a plurality of regions. Each of the regions may comprise one imaging area containing a feature of wafer 308. The acquired images may comprise multiple images of a single imaging area of wafer 308 sampled multiple times over a time sequence or may comprise multiple images of different imaging areas of wafer 308. The multiple images may be stored in the storage. In some embodiments, controller 309 may be configured to perform image processing steps with the multiple images of the same location of wafer 308.

In some embodiments, controller 309 may include measurement circuitries (e.g., analog-to-digital converters) to obtain a distribution of the detected secondary electrons. The electron distribution data collected during a detection time window, in combination with corresponding scan path data of each of primary beamlets 311, 312, and 313 incident on the wafer surface, can be used to reconstruct images of the wafer structures under inspection. The reconstructed images can be used to reveal various features of the internal or external structures of wafer 308, and thereby can be used to reveal any defects that may exist in the wafer.

In some embodiments, controller 309 may control the motorized stage to move wafer 308 during inspection of wafer 308. In some embodiments, controller 309 may enable the motorized stage to move wafer 308 in a direction continuously at a constant speed. In other embodiments, controller 309 may enable the motorized stage to change the speed of the movement of wafer 308 over time depending on the steps of scanning process.

Although electron beam tool 304 as shown in FIG. 3C uses three primary electron beams, it is appreciated that electron beam tool 304 may use a single charged-particle beam imaging system (“single-beam system”), or a multiple charged-particle beam imaging system (“multi-beam system”) with two or more number of primary electron beams. The present disclosure does not limit the number of primary electron beams used in electron beam tool 304. It should also be understood that the method of the present disclosure, while sometimes described in reference to an SEM, can be applied to or on any suitable metrology tool where determining optimal FOVs is advantageous, such as an SEM, an X-ray diffractometer, an ultrasound, an optical imaging device, etc. Additionally, the operations described herein can be applied in multiple metrology apparatuses, steps, or determinations.

Images, from, e.g., the system of FIG. 3A, 3B, and/or 3C, may be processed to extract dimensions, shapes, contours, or other information that describe the edges of objects, representing semiconductor device structures, in the image. The shapes, contours, or other information may be quantified via metrics, such as edge placement error (EPE), CD, etc. at user-defined cut-lines or in other locations. These shapes, contours, or other information may be used to optimize a patterning process, for example. Information from the images may be used for model calibration, defect inspection, and/or for other purposes.

For example, template matching is an image or pattern recognition method or algorithm in which an image which comprises a set of pixels with pixel values is compared to a template contour. The template can comprise a set of pixels with pixel values, or can comprise a function (such as a smoothed function) of pixel values along a contour. The template contour can be stepped across the image template in increments across a first and a second dimension (i.e., across both the x and the y axis of the image) and a similarity indicator determined at each position. Similarly, for shape fitting, the shape of the template contour is compared to, and adjusted based on, point locations extracted from the image in order to determine a shape of the template contour which best matches the image. The shape of the template contour can be iteratively adjusted in increments and the similarity indicator can be determined and/or adjusted for each shape. The similarity indicator is determined based on the distances between the extracted contour points from the image and corresponding locations on the template contour for each location along the template contour. The matching location and/or shape of the template contour can then be determined based on the similarity indication. For example, the template contour can be matched to the position with the highest similarity indicator, or multiple occurrences of the template contour can be matched to multiple positions for which the similarity indicator is larger than a threshold. Template matching and/or shape fitting can be used to locate features which correspond to template contours once a template contour is matched to a position on an image. A matched position, shape or dimension can be used as a determined location, shape or dimension of the corresponding feature. Accordingly, dimensions, locations, and distances can be identified, and lithographic information, analysis, and control provided.

SEM images often provide one of the highest resolution and most sensitive image for multiple layer structures. Top-down SEM images can therefore be used to determine relative offset between features of the same or different layers, though template matching or shape fitting can also be used on optical or other electromagnetic images. As described above, an SEM may be an electron beam inspection apparatus that yields an image of a structure (e.g., some or all the structure of a device, such as an integrated circuit) exposed or transferred on a substrate. A primary electron beam emitted from an electron source is converged by a condenser lens and then passes through a beam deflector and an objective lens to irradiate a substrate. When the substrate is irradiated with the electron beam, secondary electrons and backscattering electrons are generated from the substrate. The secondary electrons are detected by a secondary electron detector. The backscattering electrons are detected by a backscatter electron detector. A two-dimensional electron beam image can be obtained by detecting the electrons generated from the sample in synchronization with, e.g., two dimensional scanning of the electron beam by a beam deflector or with repetitive scanning of the electron beam by beam, together with continuous movement of the substrate. Thus, in some embodiments, the SEM has a field of view for the electron beam defined by the angular range into which the electron beam can be provided by the electron beam inspection apparatus (e.g., the angular range through which the deflector can provide the electron beam). A signal detected by the secondary electron detector may be converted to a digital signal by an analog/digital (A/D) converter, and the digital signal may be sent to an image processing system for eventual display.

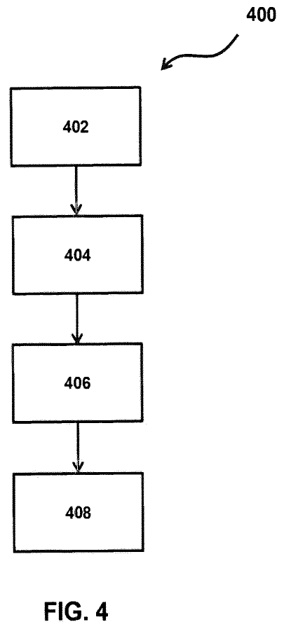

FIG. 4 illustrates an exemplary method 400 of characterizing features of an image, according to an embodiment of the present disclosure. In some embodiments, method 400 comprises determining and/or otherwise obtaining 402 a template contour, comparing 404 the template contour and the extracted contour points of a feature on the image, determining 406 a matching geometry and/or a matching position of the template contour with the feature, determining 408 a metrology metric, and/or other operations. In some embodiments, a non-transitory computer readable medium stores instructions which, when executed by a computer, cause the computer to execute one or more of operations 402-408, and/or other operations. The operations of method 400 are intended to be illustrative. In some embodiments, method 400 may be accomplished with one or more additional operations not described, and/or without one or more of the operations discussed. For example, operation 408 and/or other operations may be optional. Additionally, the order in which the operations of method 400 are illustrated in FIG. 4 and described herein is not intended to be limiting. In some embodiments, one or more portions of method 400 may be implemented (e.g., by simulation, modeling, etc.) in one or more processing devices (e.g., one or more processors). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400, for example.

Because of design tolerances, structure building requirements, and/or other factors, some layers of a structure can obscure other layers—either physically or electronically—when viewed in a two-dimensional plane such as captured in an SEM image or an optical image. For example, metal connections can obscure images of contact holes during multi-layer via construction. Such features comprise blocking structures. When a feature is blocked or obscured by another feature of the IC, determining a position of the blocked feature is more difficult. A blocked feature has a reduced contour when viewed in an image, which tend to reduce the agreement between a template and the blocked feature, and therefore complicates feature position determination. Advantageously, as described above, method 400 comprises shape fitting with template contour sliding and adaptive weighting.

It should be understood that the method of the present disclosure, while sometimes described in reference to an SEM image, can be applied to or on any suitable image, such as an TEM image, an X-ray image, an ultrasound image, optical image from image-based overlay metrology, optical microscopy image, etc. Additionally, the operations described herein can be applied in multiple metrology apparatuses, steps, or determinations. For example, template contour fitting can be applied in EPE, overlay (OVL), and CD metrology.

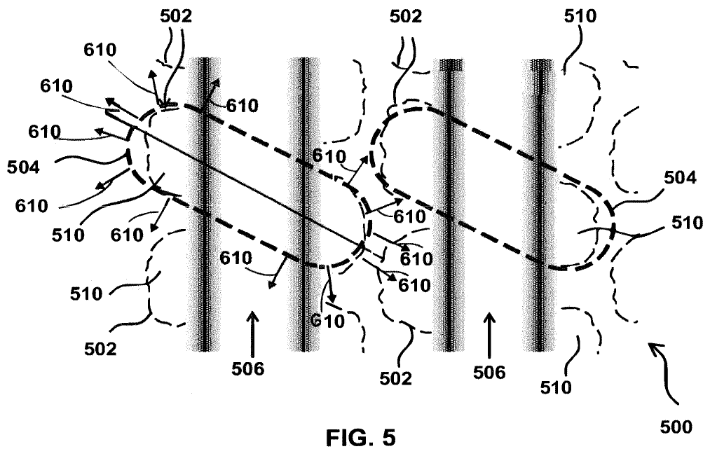

By way of a non-limiting example, FIG. 5 illustrates an SEM image 500 with extracted contour points 502 (illustrated in dashed lines), a template contour 504, and blocking structures 506. The example template contour 504 corresponds to the shape (e.g., generally oval or ellipse shaped) of features 510 (from which extracted contour points 502 were extracted) in a blocked layer. However, only the ends of each oval are visible due to blocking structures 506, which obscure the center portion of each feature 510. Changing the shape of template contour 504 to correspond to only the visible portion of feature 510 (i.e., the rounded ends of each oval end of a feature 510 without an overlapping portion blocked by the rectangular shape of a blocking structure 506) would hinder a determination of the location of a blocked feature 510, because the visible portion of the blocked feature 510 changes based on both offset and overlay.

As shown in FIG. 5, a blocking structure 506 may comprise a portion of image 500 that represents a physical feature (e.g., a line or channel in this example) in a layer of a semiconductor structure. The physical feature blocks a view of a portion (e.g., the center of the oval) of a feature 510 of interest in image 500 because of its location in the layer of the semiconductor structure relative to feature 510 of interest. Feature 510 of interest is a feature from which the contour points 502 are extracted.

Returning to FIG. 4, determining and/or otherwise accessing 402 a template contour (e.g., template contour 504 shown in FIG. 5) comprises determining a contour that corresponds to a set of contour points (e.g., contour points 502 shown in FIG. 5) extracted from an image (e.g., image 500 shown in FIG. 5). The image can be an acquired image or synthetic image, e.g., simulated or synthesized image. The image can be captured or acquired via optical or other optical imaging or though scanning electron microscopy. The image can be obtained from other software or data storage. In some embodiments, the template contour is determined based on one or more acquired or synthetic images of a measurement structure using contour extraction techniques. In some embodiments, the template contour is determined by selecting a first feature of a synthetic image of the measurement structure and generating the template contour based at least in part on the first feature. In some embodiments, the template contour is determined based on one or more pixel values for the one or more acquired or synthetic images; and/or based on one or more reference shapes from one or more design files associated with the image.

For example, in some embodiments, a template contour may be determined based on multiple obtained images or averages of images. These can be used to generate the template contour based on pixel contrast and stability of the obtained images. In some embodiments, the template contour is composed of constituent contour templates, such as multiple (of the same or different) patterns selected using a grouping process based on certain criteria and grouped together in one template. The grouping process may be performed manually or automatically. A composed template contour can be composed of multiple template contours that each include one or multiple patterns, or of a single template contour that includes multiple patterns. In some embodiments, information about a layer of a semiconductor structure can be used to generate a template contour. A computational lithography model, one or more process models, such as a deposition model, etch model, CMP (chemical mechanical polishing) model, etc. can be used to generate a template contour based on GDS or other information about the layer of the measurement structure. A scanning electron microscopy model can be used to refine the template contour.

As another example, a feature may be selected from an image of a layer of a semiconductor structure. The feature can be an image of a physical feature, such as a contact hole, a metal line, an implantation area, etc. The feature can also be an image artifact, such as edge blooming, or a buried or blocked artifact. A shape for the feature is determined. The shape can be defined by GDS format, a lithograph model simulated shape, a detected shape, etc. One or more process models may be used to generate a top-down view of the feature. The process model can include a deposition model, an etch model, an implantation model, a stress and strain model, etc. The one or more process models can generate a simulated shape for an as-fabricated feature, which defines the template contour.

In some embodiments, one or more graphical (e.g., 2-D shape based) inputs for the feature may be entered or selected by a user. The graphical input can be an image of the as-fabricated feature, for example. The graphical input can also be user input or based on user knowledge, where a user updates the as-fabricated shape based in part experience of similar as-fabricated elements. For example, the graphical input can be corner rounding or smoothing. A scanning electron microscopy model may be used to generate a synthetic SEM image of the feature. A template contour is then generated based on the synthetic SEM image.

Comparing 404 the template contour (e.g., template contour 504 shown in FIG. 5) and extracted contour points (e.g., contour points 502 shown in FIG. 5) is based on a plurality of distances between locations on the template contour and the extracted contour points. The plurality of distances is weighted based on the locations on the template contour, overlap of the locations on the template contour with a blocking structure in the image, and/or other information. In some embodiments, the locations where the distances are determined on a template contour are user defined, automatically determined based on a curvature of the template contour, determined based on key locations of interest on template contour 504, and/or determined in other ways. For example, in some embodiments, the plurality of distances correspond to key locations of interest such as edge placement (EP) gauge lines. An EP gauge line is normal to the template contour. In some embodiments, a distance (e.g., dⱼ) in the field of image processing may be a Euclidean distance, a ‘city block’ distance, a chessboard distance, etc. In some embodiments, comparing 404 comprises determining similarity (e.g. a score and/or other indicator) between the template contour and the extracted contour points based on the weighted distances.

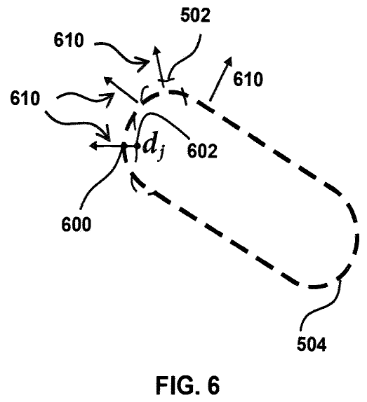

For example, FIG. 6 illustrates a single template contour 504 and one example distance, dⱼ, between a location 600 on template contour 504 and an extracted contour point 602 (that is part of contour points 502). As shown in FIG. 6, distance dⱼ corresponds to an edge placement (EP) gauge line 610, which is normal to template contour 504. In some embodiments, the similarity determination can be based on a weighted sum of the plurality of distances, dⱼ. Weights (Eⱼ described below) associated with corresponding locations (such as location 600) on the template contour 504 can be defined, e.g., by a contour weight map. In some embodiments, the weights (Eⱼ) and/or locations where distances (dⱼ) are determined on template contour 504 can be user defined, determined based on a curvature of template contour 504, determined based on key locations of interest on template contour 504, and/or determined in other ways.

According to embodiments of the present disclosure, the contour weight map may include weighting values that can be adjusted to account for areas of template contour 504 which correspond to blocked areas (e.g., areas blocked by blocking structures 506 shown in FIG. 5) as the template's location with reference to the image changes. In some embodiments, the weight map can be adjusted, updated, or adapted based on the location of template contour 504 on the image (e.g., image 500 shown in FIG. 5) and/or relative to any blocking structures (e.g., blocking structures 506). For example, a weight map for a template contour can be weighted relatively high in areas where the template contour does not overlap a blocking feature, and weighted less in areas where the template contour does overlap with the blocking feature. The weight map can be updated for each location on the template contour (e.g., as the template contour slides across the image or is otherwise compared to multiple positions on the image) to generate an adaptive weighting and to enable the template contour to be matched to one or more best positions, even when the template contour is blocked or obscured by a blocking structure. In some embodiments, a weight map for a template contour can be updated based on a pixel value (e.g., brightness) of the image at the location on the template contour, based on a distance from the blocking structure to the template contour, and/or based on other information.

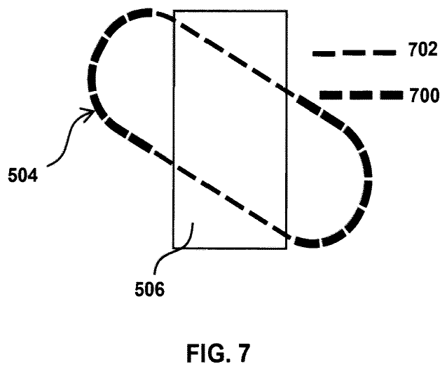

By way of a non-limiting example, FIG. 7 illustrates template contour 504, a blocking structure 506, and corresponding locations 700 of relatively high weight and locations 702 of relatively low weight (e.g., a weight map) along template contour 504. Locations 700 along template contour 504 are weighted high where template contour 504 does not overlap blocking structure 506. Locations 702 along template contour 504 weighted less where template contour 504 does overlap with blocking structure 506. This weighting accounts for locations (e.g., locations 702) on template contour 504 which correspond to blocked portions (e.g., portions blocked by blocking structure 506). As described above, this weighting can be adjusted, updated, or adapted based on the location of template contour 504 on an image (e.g., image 500 shown in FIG. 5) and/or relative to any blocking structures (e.g., blocking structures 506).

A weight map need not be explicitly associated with pixel brightness and/or location, and can instead be described as a function, and/or described in other ways. For example, a weight map can be described as a step function, a sigmoid function, and/or other functions based on a distance from a blocking structure along the template contour edge. The weight map can be adjusted based on relative position of the template contour versus the image, so an weight map may be a starting or null state weight map, which is then adjusted as the template contour is matched to various portions of the image. This is further described below.

Returning to FIG. 4, comparing 404 may comprise a coarse determination step, and a fine determination step, and/or other operations. The coarse determination step comprises determining and/or otherwise obtaining blocking structure weights (Bⱼ, further described below) for locations on a blocking structure (e.g., blocking structure 506 shown in FIG. 5), and multiplying the blocking structure weights by weights (Eⱼ) associated with corresponding locations on a template contour (e.g., template contour 504 shown in FIG. 5) that overlap with the blocking structure to determine a total weight (Wⱼ, further described below) for each location on the contour. The coarse determination step comprises determining a coarse similarity score and/or other similarity indicator based on a weighted sum of the plurality of distances (dⱼ) multiplied by the total weights (Wⱼ). The multiplying and determining the coarse similarity score (for example) is then repeated for multiple geometries or positions of the template contour relative to the extracted contour points (e.g., extracted contour points 502 shown in FIG. 5) to determine an optimized course position of the template contour relative to the extracted contour points.

In some embodiments, the comparing comprises coarse positioning of the template contour at a location on the image, and comparing the template contour with unblocked features of interest in the image using an adaptive weight map (e.g., a weight map that changes with location on the template contour and overlap with any blocking structures) as an attenuation factor. A coarse similarity score or other indicator is calculated for this position (and then similarly recalculated for other positions). The coarse similarity indicator can include, a weight normalized sum of dⱼ*Wⱼ, a weight normalized of dⱼ*dⱼ*Wⱼ. The similarity indicator can also be user defined. In some embodiments, multiple similarity indicators can be used or different similarity indicators can be used for different areas of either the template contour and/or the image itself.

In some embodiments, the blocking structure weights (Bⱼ) are determined based on an intensity profile of pixels in the image that form the blocking structure and/or other information. In some embodiments, the blocking structure weights follow a step function, a sigmoid function, a user defined function, and/or other functions. In some embodiments, a weight map for the blocking structure may be accessed electronically. The weight map may include weighting values based on the blocking structure shape, size, and/or other characteristics (e.g., the weights may be based on a distance from an edge of the blocking structure) and/or the weighting values can be determined or updated based on a position of the blocking structure on or with respect to the image and/or the template contour.

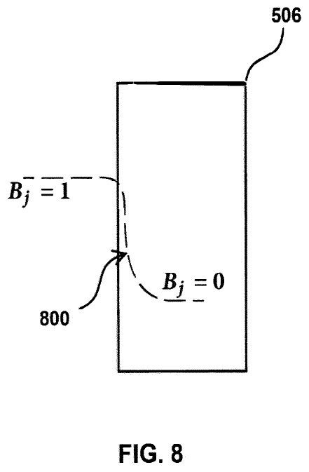

For example, FIG. 8 illustrates example blocking structure weights (Bⱼ) that follow a sigmoid function 800 relative to a blocking structure 506. In this example, blocking structure weights, Bⱼ, at locations away from blocking structure 506 (where underlying features in an image would not be blocked) are equal to one, while blocking structure weights, Bⱼ, near the middle of blocking structure 506 (where underlying features in the image would be blocked) are equal to zero. Blocking structure weights, Bⱼ, follow a sigmoid function 800 relative to the edge 802 of blocking structure 506 (where underlying features may or may not be blocked) and transition from being equal to one to being equal to zero. The sharpness or steepness of the transition from one to zero may be determined based on an intensity profile of pixels in the image that form the blocking structure and/or other information, for example.

Returning to FIGS. 4 and 5, at each new sliding position, the overlap (or intersection) between a blocking structure 506 and a template contour 504 varies. As described above, a total weighting (Wⱼ multiplied by distances di) can be used to determine the coarse similarity score (i.e., a similarity indicator or another measure of matching between the blocked image template and the image of the measurement structure). The total weight (Wⱼ) is calculated by multiplying the weight map of the template contour (Eⱼ) and the weight map of the blocking structure (Bⱼ). During sliding, the intersection area changes, and so the total weight changes. The weight map of the template contour (Eⱼ) and/or the blocking structure (Bⱼ) may remain constant, for example, but where an adaptive weight map is generated by a multiplication or other convolution of the weight map of the template contour and the weight map of the blocking structure, either or both weight maps may be adjusted for each sliding position.

In any case (i.e., if the weight map for the template contour and/or the blocking structure varies, or if the weight map for the template contour and/or the blocking structure is a constant), this generates an adaptive weight map per sliding position and means that an adaptive weight map is used to calculate the coarse similarity at each sliding position. In other embodiments, at a new position, the weight maps can be updated based on the image of the semiconductor structure (or a property such as pixel value, contrast, sharpness, etc. of the image of the measurement structure), a weight map can be updated based on blocking image template (such as updated based on an overlap or convolution score), or the weight maps can be updated based on a distance from an image or focus center, for example.

By way of a non-limiting example, a coarse similarity score (S_{k coarse} in this example) at template sliding position k, can be determined as:

$${S}_{k coarse} = ( {Σ}_{j} {d}_{j} * {W}_{j} ) / {Σ}_{j} {W}_{j} ,$$

over all EP gauge lines (e.g., 610 shown in FIGS. 5 and 6), where dⱼ is a distance vector at a EP gauge line j location on the template contour (as described above), and Wⱼ is the total weight. Wⱼ is determined based on (e.g., by multiplying and/or other combinations of) Eⱼ and Bⱼ. Eⱼ is the weight map for the template contour, and Bⱼ is the weight map for the blocking structure. In some embodiments, Wⱼ is configured such that it has a lower value for blocked locations along a template contour, and a higher value for unblocked locations. Note that Wⱼ depends on the relative sliding position of the template contour on the image.

Continuing with comparing 404, the fine determination step may comprise: adjusting the weights (E_{j adjusted}) associated with the corresponding locations on the template contour (e.g., template contour 504 shown in FIG. 5) that overlap with a blocking structure (e.g., blocking structure 506 shown in FIG. 5). Adjusting the weights associated with the corresponding locations on the template contour that overlap with the blocking structure may comprise: updating a weight (E_{j adjusted}) for a given position on the template contour based on at least one of pixel values of the image, a location of the blocking structure in the image relative to the template contour, a previously identified structure located on the image, a location of the template contour, a relative position of the template contour with respect to the extracted contour points, or a combination thereof. In the fine determination step, T_{K fine} is minimized by trying one or more different Eⱼ. This is to avoid an initial Eⱼ that is not optimal and may bias the best shape matching/fitting position.

The fine determination step also includes combining the blocking structure weights (Bⱼ) by the adjusted weights (Eⱼ adjusted) associated with corresponding locations on the template contour (e.g., template contour 504 shown in FIG. 5) that overlap with the blocking structure (e.g., blocking structure 506 shown in FIG. 5) to determine a total weight (Wⱼ) for each location on the template contour. In some embodiments, the total weight (Wⱼ) be obtained by multiplying Bⱼ and Eⱼ adjusted. However, it will be appreciated that the present disclosure is not limited thereto, and the total weight can be obtained (Wⱼ) by any suitable operation of combining Bⱼ and E_{j adjusted} in any mathematical form without departing from the scope of the present disclosure. A first fine similarity score (S_{k fine}) and/or other indicator may be determined based on a weighted sum of the plurality of distances (dⱼ) multiplied by the total weights (Wⱼ). A second fine similarity score (T_{k fine}, described below) and/or other indicator may be determined based on a weighted sum of the plurality of distances (dⱼ) multiplied by the total weights (Wⱼ) only for unblocked locations on the template contour that do not overlap with the blocking structure.

For example, the first fine similarity score (in this example) can be determined as:

$${S}_{K fine} = ( {Σ}_{j} {d}_{j} * {W}_{j} ) / {Σ}_{j} {W}_{j} ,$$

over all EP gauge lines (e.g., 610 shown in FIGS. 5 and 6), where dⱼ is the distance vector at a EP gauge line location on the template contour (as described above), and Wⱼ is the total weight. Wⱼ is determined based on (e.g., by multiplying and/or other combinations of) E_{j adjusted} and Bⱼ. The second fine similarity score (in this example) can be determined as:

$${T}_{K fine} = ( {Σ}_{j} {d}_{j} * {E}_{j adjusted} ) / {Σ}_{j} {E}_{j adjusted} ,$$

over all unblocked EP gauge lines (as shown and described above with respect to FIGS. 5-8). Note that the similarity score equations for S_{K}, T_{K}, S_{K} (fine), and T_{K} (fine), and weights Wⱼ, Eⱼ, and Eⱼ (adjusted) can be fined tuned automatically and/or by a user per use case.

In some embodiments, the adjusting, the multiplying, and the determining the first and second fine similarity scores can be repeated for multiple geometries or positions of the template contour relative to the extracted contour points to determine an optimized fine position of the template contour relative to the extracted contour points. For example, among different sliding positions, a coarse best fit position for the template contour may be found at min (S_{K}) in the coarse step first, and then near that coarse best fit position, the fine step is performed to determine a fine best fit position for the template contour as an interpolated minimal combined fine step similarity score min (FS_{K}), where FS_{K}=c1*S_{Kfine}+c2*T_{Kfine,} and where c1 and c2 are user defined coefficients. In some embodiments, c1 and c2 are relative weights between S_{K} and T_{K}. For example, if c1=0, the best fit position is determined by a sum of dj in a non-blocking area. If c2=0, the best fit position is determined by all dj. If c1 and c2 have any value larger than 0, the user may choose different levels of emphasis on dj in the non-blocking area. Depending on the image quality on different process layers, the user can tune c1 and c2. For example, if the blocking area has very low contrast, c2>>c1, may be chosen, such as c1=0, c2=1,

In some embodiments, the total weights (Wⱼ) for unblocked locations on the template contour are defined by a threshold on the weights associated with the corresponding locations on the template contour. For example, unblocked EP gauge locations can be defined by E_{j adjusted}>threshold. The threshold may be determined based on prior process knowledge, characteristics of the image, relative locations of the template contour and the blocking structure, and/or other information. The threshold may be determined automatically (e.g., by one or more processors described herein), manually by a user, based on the above and/or in other ways.

The iteration for multiple positions may continue until the template contour is matched to a position on the image, or until the template contour has moved through all specified locations. Matching can be determined based on a threshold and/or maximum similarity indicator as described above, and/or other information. Matching can comprise matching multiple occurrences based on a threshold similarity score. After the template contour is matched, a measure of offset and/or other process stability can be determined—such as an overlay, an edge placement error, a measure of offset—based on the matched position.

Determining 406 a matching geometry and/or a matching position of the template contour with the image is based on comparison 404 and/or other information. Determining 406 can include the iterations for the multiple positions described above, e.g., with respect to the coarse and fine determination steps, performing a final position adjustment, iteratively adjusting the geometry of the template contour based on the distances and weighting described above, adjusting a scaling of the template contour, and/or other adjusting.

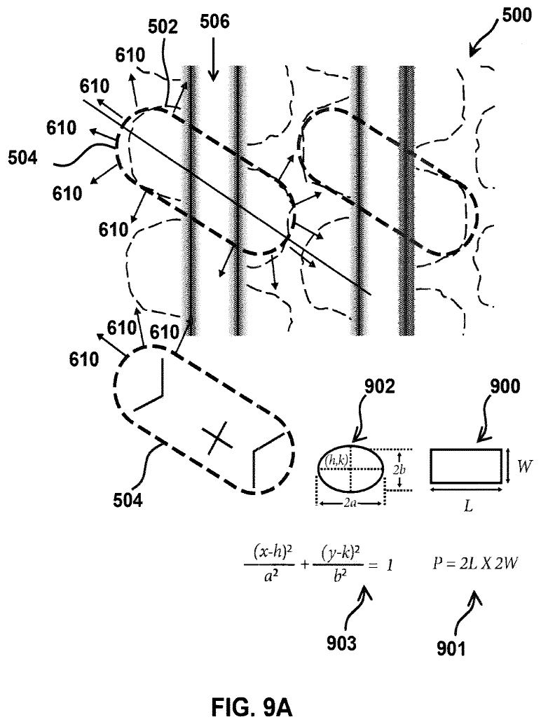

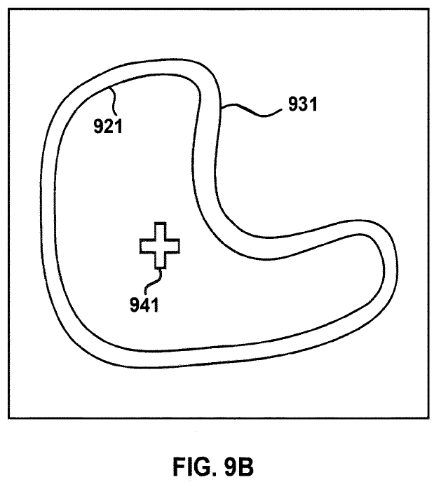

In some embodiments, adjusting the geometry of the template contour comprises changing a shape of one or more portions of the template contour. For example, FIG. 9A illustrates how template contour 504 is formed by integrating portions of a rectangle 900, and portions of an ellipse 902, that each have their own equations 901 and 903 respectively with geometry parameters (e.g., length L, width W, perimeter P, center location h k, axis length 2a, axis length 2b, etc.) that describe portions of the shape of template contour 504. The shape of one or more portions of template contour 504 can be adjusted (e.g., to better match extracted contour points 502) by changing one or more of the parameters of equations 901 and/or 903, and/or other equations. In this example, the geometry parameters may be updated and, in turn, a new template contour may be generated. These steps may be repeated until min (S_{K}) reaches an acceptable level as described above. Note that FIG. 9A is just an example. Other shapes may be used without departing from the scope of the disclosure. This also applies for the shapes shown in other figures.

For example, FIG. 9B illustrates an arbitrary shape template contour 951. Template contour 951 comprises an inner contour line 921 and an outer contour line 931. Template contour 951 can also comprise a “hot spot” or reference point 941, which is used to determine a measure of offset relative to other templates, patterns, or features of the image of the structure. Inner contour line 921 and an outer contour line 931 can be used as a scaled template contour for shape fitting with adaptive weighting.

Returning to FIG. 4, in some embodiments, determining 406 the matching position of the template contour relative to the image comprises translation, scaling, and/or rotation of the template contour relative to the extracted contour points. Translation may include moving the template contour relative to extracted contour points of a feature in the image in an x direction, a y direction, and/or a combination of x and y directions (e.g., the sliding described above). Rotation of the template contour my include rotating the template contour around or about a given axis of the extracted contour points and/or other features of the image.

In some embodiments, scaling comprises determining a scale factor range. For example, a scale factor range may include several scale factors ranging from about 2% smaller than a current size of the template contour to about 2% larger than the current size of the template contour. In this example, the scale factors may be 0.98, 0.99, 1.00, 1.01, and 1.02. Scaling comprises determining corresponding contour locations for each template contour whose scale factor is not equal to one (e.g., a template contour that has been scaled by a scale factor of 0.98, 0.99, 1.01, and/or 1.02) using a same line direction (e.g., a direction of an EP gauge line 610 direction shown in FIG. 5) as a template contour whose scale factor is equal to one (e.g., template contour 504 shown in FIG. 5). Scaling comprises determining a distance (e.g., Iⱼ, described below) from a scaled template contour to an intersection point with the extracted contour points (e.g., extracted contour points 502 shown in FIG. 5). Scaling comprises determining similarities (e.g., a similarity score such as Sₖ described above, and/or other indicators) for each scale factor in the scale factor range; and adjusting the geometry or position of the template contour relative to the extracted contour points based on the similarities for each scale factor in the scale factor range.

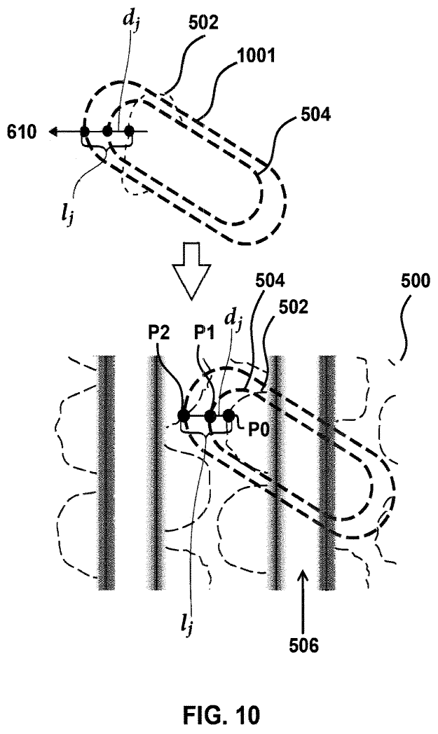

By way of a non-limiting example, FIG. 10 illustrates an example of an x and y scaling template contour 504. In FIG. 10, template contour 504 has a scaling factor equal to 1.00. FIG. 10 also illustrates a template contour 1001 that has been scaled to a size larger than template contour 504. Template contour 1001 was generated by determining corresponding scaled contour locations for each location along template contour 504 using a same line direction of an EP gauge line 610 along which a distance dⱼ was determined. Scaling comprises determining a distance Iⱼ, from scaled template contour 1001 to an intersection point with the extracted contour points 502. Note that dⱼ and Iⱼ share the same intersection point p0 on the extracted contour, and p1 and p2 are predefined EP gauge positions on template contour 504 and template contour 1001 respectively. Scaling comprises determining similarities (e.g., a similarity score such as Sₖ described above, and/or other indicators) for each scale factor in the scale factor range; and adjusting the geometry or position of the template contour relative to the extracted contour points based on the similarities for each scale factor in the scale factor range.

Returning to FIG. 4, determining 408 a metrology metric is based on an adjusted geometry or position of the template contour relative to the extracted contour points, and/or other information. This may include, for example, determining overlay between a first test feature and second test feature based on an adjusted geometry or position of the template contour relative to the extracted contour points. The features may be on the same process layer or on different layers. A measure of overlay is determined the layer-to-layer shift between layers which are designed to align or have a certain or known relationship. A measure of overlay can be determined based on an offset vectors (e.g., describing an x, y position) for corresponding features in different layers of the structure, for example. Overlay can also be a one-dimensional value (e.g., for semi-infinite line features), or a two-dimensional value (e.g., in the x and y directions, in the r and theta directions). Further, it is not required that offset be determined in order to determine overlay—instead overlay can be determined based on a relative position of features of two layers and a reference or planned relative position of those features.

In some embodiments, determining 408 a metrology metric includes providing such information for various downstream applications. In some embodiments, this includes providing the metrology metric for adjustment and/or optimization of the pattern, the patterning process, and/or for other purposes. For example, in some embodiments, the metrology metric is configured to be provided to a cost function to facilitate determination of costs associated with individual patterning process variables. Providing may include electronically sending, uploading, and/or otherwise inputting the metrology metric into the cost function. In some embodiments, this may be integrally programmed with the instructions that cause others of operations 402-408 (e.g., such that no “providing” is required, and instead data simply flows directly to the cost function.)

Adjustments to a pattern, a patterning process (e.g., a semiconductor manufacturing process), and/or other adjustments may be made based on the metrology metric, the cost function, and/or based on other information. Adjustments may including changing one or more patterning process parameters, for example. Adjustments may include pattern parameter changes (e.g., sizes, locations, and/or other design variables), and/or any adjustable parameter such as an adjustable parameter of the etching system, the source, the patterning device, the projection optics, dose, focus, etc. Parameters may be automatically or otherwise electronically adjusted by a processor (e.g., a computer controller), modulated manually by a user, or adjusted in other ways. In some embodiments, parameter adjustments may be determined (e.g., an amount a given parameter should be changed), and the parameters may be adjusted from prior parameter set points to new parameter set points, for example.

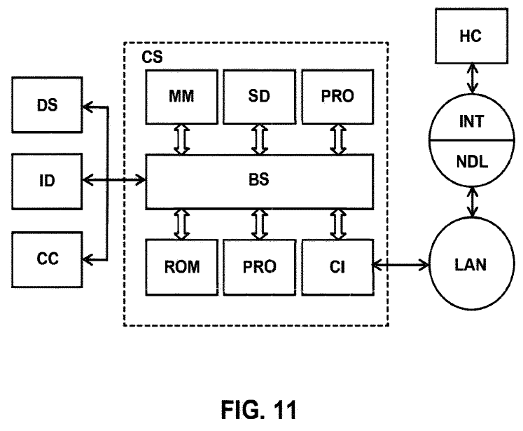

FIG. 11 is a diagram of an example computer system CS that may be used for one or more of the operations described herein. Computer system CS may be similar to and/or the same as computer system CL shown in FIG. 2, for example. Computer system CS includes a bus BS or other communication mechanism for communicating information, and a processor PRO (or multiple processors) coupled with bus BS for processing information. Computer system CS also includes a main memory MM, such as a random-access memory (RAM) or other dynamic storage device, coupled to bus BS for storing information and instructions to be executed by processor PRO. Main memory MM also may be used for storing temporary variables or other intermediate information during execution of instructions by processor PRO. Computer system CS further includes a read only memory (ROM) ROM or other static storage device coupled to bus BS for storing static information and instructions for processor PRO. A storage device SD, such as a magnetic disk or optical disk, is provided and coupled to bus BS for storing information and instructions.

Computer system CS may be coupled via bus BS to a display DS, such as a cathode ray tube (CRT) or flat panel or touch panel display for displaying information to a computer user. An input device ID, including alphanumeric and other keys, is coupled to bus BS for communicating information and command selections to processor PRO. Another type of user input device is cursor control CC, such as a mouse, a trackball, or cursor direction keys for communicating direction information and command selections to processor PRO and for controlling cursor movement on display DS. This input device typically has two degrees of freedom in two axes, a first axis (e.g., x) and a second axis (e.g., y), that allows the device to specify positions in a plane. A touch panel (screen) display may also be used as an input device.

In some embodiments, portions of one or more methods described herein may be performed by computer system CS in response to processor PRO executing one or more sequences of one or more instructions contained in main memory MM. Such instructions may be read into main memory MM from another computer-readable medium, such as storage device SD. Execution of the sequences of instructions included in main memory MM causes processor PRO to perform the process steps (operations) described herein. One or more processors in a multi-processing arrangement may also be employed to execute the sequences of instructions contained in main memory MM. In some embodiments, hard-wired circuitry may be used in place of or in combination with software instructions. Thus, the description herein is not limited to any specific combination of hardware circuitry and software.

The term “computer-readable medium” and/or “machine readable medium” as used herein refers to any medium that participates in providing instructions to processor PRO for execution. Such a medium may take many forms, including but not limited to, non-volatile media, volatile media, and transmission media. Non-volatile media include, for example, optical or magnetic disks, such as storage device SD. Volatile media include dynamic memory, such as main memory MM. Transmission media include coaxial cables, copper wire and fiber optics, including the wires that comprise bus BS. Transmission media can also take the form of acoustic or light waves, such as those generated during radio frequency (RF) and infrared (IR) data communications. Computer-readable media can be non-transitory, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge. Non-transitory computer readable media can have instructions recorded thereon. The instructions, when executed by a computer, can implement any of the operations described herein. Transitory computer-readable media can include a carrier wave or other propagating electromagnetic signal, for example.

Various forms of computer readable media may be involved in carrying one or more sequences of one or more instructions to processor PRO for execution. For example, the instructions may initially be borne on a magnetic disk of a remote computer. The remote computer can load the instructions into its dynamic memory and send the instructions over a telephone line using a modem. A modem local to computer system CS can receive the data on the telephone line and use an infrared transmitter to convert the data to an infrared signal. An infrared detector coupled to bus BS can receive the data carried in the infrared signal and place the data on bus BS. Bus BS carries the data to main memory MM, from which processor PRO retrieves and executes the instructions. The instructions received by main memory MM may optionally be stored on storage device SD either before or after execution by processor PRO.

Computer system CS may also include a communication interface CI coupled to bus BS. Communication interface CI provides a two-way data communication coupling to a network link NDL that is connected to a local network LAN. For example, communication interface CI may be an integrated services digital network (ISDN) card or a modem to provide a data communication connection to a corresponding type of telephone line. As another example, communication interface CI may be a local area network (LAN) card to provide a data communication connection to a compatible LAN. Wireless links may also be implemented. In any such implementation, communication interface CI sends and receives electrical, electromagnetic, or optical signals that carry digital data streams representing various types of information.

Network link NDL typically provides data communication through one or more networks to other data devices. For example, network link NDL may provide a connection through local network LAN to a host computer HC. This can include data communication services provided through the worldwide packet data communication network, now commonly referred to as the “Internet” INT. Local network LAN (Internet) may use electrical, electromagnetic, or optical signals that carry digital data streams. The signals through the various networks and the signals on network data link NDL and through communication interface CI, which carry the digital data to and from computer system CS, are exemplary forms of carrier waves transporting the information.

Computer system CS can send messages and receive data, including program code, through the network(s), network data link NDL, and communication interface CI. In the Internet example, host computer HC might transmit a requested code for an application program through Internet INT, network data link NDL, local network LAN, and communication interface CI. One such downloaded application may provide all or part of a method described herein, for example. The received code may be executed by processor PRO as it is received, and/or stored in storage device SD, or other non-volatile storage for later execution. In this manner, computer system CS may obtain application code in the form of a carrier wave.

Embodiments of the present disclosure can be further described by the following clauses.

1. A method of characterizing features of an image, comprising:
accessing a template contour;
comparing the template contour and extracted contour points based on a plurality of distances between locations on the template contour and the extracted contour points, wherein the plurality of distances is weighted based on overlap of the locations on the template contour with a blocking structure in the image; and
based on the comparing, determining a matching geometry and/or a matching position of the template contour with the extracted contour points from the image.
   2. The method of clause 1, wherein the plurality of distances is further weighted based on the locations on the template contour.
   3. The method of clause 1 or 2, wherein determining the matching position comprises placing the template contour in various locations on the image, and selecting the matching position from among the various locations based on the comparing.
   4. The method of any of clauses 1-3, wherein determining the matching geometry comprises generating various geometries of the template contour on the image, and selecting the matching geometry from among the various geometries based on the comparing.
   5. The method of any of clauses 1-4, wherein the comparing comprises determining similarity between the template contour and the extracted contour points based on the weighted distances.
   6. The method of clause 5, wherein the similarity is determined based on a weighted sum of the plurality of distances.
   7. The method of clause 6, wherein the weighted sum is determined based on the overlap of the locations on the template contour with the blocking structure in the image.
   8. The method of any of clauses 1-7, wherein the plurality of distances is further weighted based on a weight map associated with the template contour.
   9. The method of any of clauses 1-8, wherein the plurality of distances is further weighted based on a weight map associated with the blocking structure.
   10. The method of any of clauses 1-9, wherein a total weight for each of the plurality of distances is determined by multiplying a weight associated with the template contour by a corresponding weight associated with the blocking structure.
   11. The method of any of clauses 1-9, wherein weights change based on positioning of the template contour on the image.
   12. The method of any of clauses 1-11, wherein the comparing comprises:
accessing blocking structure weights for locations on the blocking structure; and
determining a total weight for each location on the template contour based on the blocking structure weights and weights associated with corresponding locations on the contour that overlap with the blocking structure.
   13. The method of clause 12, wherein the comparing comprises determining a coarse similarity score based on the total weights.
   14. The method of clause 13, further comprising repeating the determining the coarse similarity score for multiple geometries or positions of the template contour relative to the extracted contour points to determine an optimized coarse position of the template contour relative to the extracted contour points.
   15. The method of any of clauses 12-14, wherein the blocking structure weights follow a step function or a sigmoid function or user defined function.
   16. The method of clauses 12-15, wherein the blocking structure weights are determined based on an intensity profile of pixels in the image that form the blocking structure.
   17. The method of any of clauses 1-16, wherein the comparing comprises:
adjusting weights associated with corresponding locations on the contour that overlap with the blocking structure; and
determining a total weight for each location on the contour multiplying blocking structure weights by the adjusted weights associated with corresponding locations on the contour that overlap with the blocking structure.
   18. The method of clause 17, wherein the comparing further comprises:
determining a first fine similarity score based on a weighted sum of the plurality of distances multiplied by the total weights; and
determining a second fine similarity score based on a weighted sum of the plurality of distances multiplied by the total weights only for unblocked locations on the contour that do not overlap with the blocking structure.
   19. The method of clause 18, wherein the comparing further comprises repeating the adjusting and the determining the first and second fine similarity for multiple geometries or positions of the template contour relative to the extracted contour points to determine an optimized fine position of the template contour relative to the extracted contour points.
   20. The method of any of clauses 17-19, wherein adjusting the weights associated with the corresponding locations on the template contour that overlap with the blocking structure comprises: updating a weight for a given position on the template contour based on at least one of pixel values of the image, a location of the blocking structure in the image relative to the template contour, a previously identified structure located on the image, a location of the template contour, a relative position of the template contour with respect to the extracted contour points, or a combination thereof.
   21. The method of any of clauses 1-20, wherein total weights for unblocked locations on the contour that do not overlap with the blocking structure are defined by a threshold on the weights associated with the corresponding locations on the contour.
   22. The method of any of clauses 1-21, wherein determining a matching geometry or a matching position of the template contour relative to the extracted contour points comprises translation, scaling, and/or rotation of the template contour relative to the extracted contour points.
   23. The method of clause 22, wherein scaling comprises:
determining corresponding contour locations for each template contour whose scale factor is not equal to one using a same line direction as a template contour whose scale factor is equal to one;
determining similarities for each scale factor in a scale factor range; and
adjusting the geometry or position of the template contour relative to the extracted contour points based on the similarities for each scale factor in the scale factor range.
   24. The method of any of clauses 1-23, wherein the locations on the template contour are user defined, determined based on a curvature of the template contour, and/or determined based on key locations of interest on the template contour.
   25. The method of any of clauses 1-24, wherein the plurality of distances correspond to edge placement (EP) gauge lines, and wherein an EP gauge line is normal to the template contour.
   26. The method of any of clauses 1-25, wherein the method further comprises determining a metrology metric based on an adjusted geometry or position of the template contour relative to the extracted contour points.
   27. The method of any of clauses 1-26, wherein the method further comprises determining overlay between a first test feature and second test feature based on an adjusted geometry or position of the template contour relative to the extracted contour points.
   28. The method of any of clauses 1-27, wherein weights associated with corresponding locations on the contour are defined by a contour weight map.
   29. The method of any of clauses 1-28, wherein the template contour is determined based one or more acquired or synthetic images of a measurement structure using contour extraction techniques.
   30. The method of any of clauses 1-29, wherein the template contour is determined by selecting a first feature of a synthetic image of a measurement structure and generating the template contour based at least in part on the first feature.
   31. The method of any of clauses 1-30, wherein the template contour is determined based on one or more pixel values for one or more acquired or synthetic images.
   32. The method of any of clauses 1-31, wherein the template contour is determined based on one or more reference shapes from one or more design files associated with the image.
   33. The method of any of clauses 1-32, wherein the blocking structure comprises a portion of the image that represents a physical feature in a layer of a semiconductor structure, the physical feature blocking a view of a portion of a feature of interest in the image because of its location in the layer of the semiconductor structure relative to the feature of interest, the feature of interest being a feature from which the contour points are extracted.
   34. The method of any of clauses 1-33, wherein the comparing comprises a coarse determination step, and a fine determination step.
   35. A non-transitory computer readable medium having instructions thereon, the instructions when executed by a computer causing the computer to perform the method of any of clauses 1-34.
   36. A system for characterizing features of an image, the system comprising one or more processors configured by machine readable instructions to perform the method of any of clauses 1-34.
   37. A non-transitory computer readable medium having instructions thereon, the instructions when executed by a computer causing the computer to perform a method of characterizing features in an image, the method comprising:
accessing a template contour that corresponds to a set of contour points extracted from the image;
comparing, by determining a similarity between, the template contour and the extracted contour points based on a plurality of distances between locations on the template contour and the extracted contour points, wherein the plurality of distances is adaptively weighted based on the locations on the template contour and whether the locations on the template contour overlap with blocking structures in the image; wherein comparing comprises:
   accessing blocking structure weights for locations on the blocking structures;
   multiplying the blocking structure weights by weights associated with corresponding locations on the contour that overlap with the blocking structures to determine a total weight for each location on the contour;
   determining a coarse similarity score based on a weighted sum of the plurality of distances multiplied by the total weights; and
   repeating the multiplying and determining the coarse similarity score operations for multiple geometries or positions of the template contour relative to the extracted contour points to determine an optimized coarse position of the template contour relative to the extracted contour points;
   adjusting the weights associated with the corresponding locations on the contour that overlap with the blocking structures;
   multiplying the blocking structure weights by the adjusted weights associated with corresponding locations on the contour that overlap with the blocking structures to determine a total weight for each location on the contour;
   determining a first fine similarity score based on a weighted sum of the plurality of distances multiplied by the total weights;
   determining a second fine similarity score based on a weighted sum of the plurality of distances multiplied by the total weights only for unblocked locations on the contour that do not overlap with the blocking structures; and
   repeating the adjusting, the multiplying, and the determining the first and second fine similarity operations for multiple geometries or positions of the template contour relative to the extracted contour points to determine an optimized fine position of the template contour relative to the extracted contour points; and
based on the comparing, determining a matching geometry or a matching position of the template contour with the extracted contour points from the image.
   38. The medium of clause 37, wherein the total weights for unblocked locations on the contour that do not overlap with the blocking structures are defined by a threshold on the weights associated with the corresponding locations on the contour.
   39. The medium of clause 37, wherein determining a matching geometry or a matching position comprises translation, scaling, and/or rotation of the template contour relative to the extracted contour points.
   40. The medium of clause 39, wherein scaling comprises:
determining a scale factor range;
determining corresponding contour locations for each template contour whose scale factor is not equal to one using a same line direction as a template contour whose scale factor is equal to one;
determining a distance from a scaled template contour to an intersection point with the extracted contour points;
determining similarities for each scale factor in the scale factor range; and
adjusting the geometry or position of the template contour relative to the extracted contour points based on the similarities for each scale factor in the scale factor range.
   41. The medium of clause 37, wherein the method further comprises determining overlay between a first test feature and second test feature based on an adjusted geometry or position of the template contour relative to the extracted contour points.

While the concepts disclosed herein may be used for manufacturing with a substrate such as a silicon wafer, it shall be understood that the disclosed concepts may be used with any type of manufacturing system (e.g., those used for manufacturing on substrates other than silicon wafers).

In addition, the combination and sub-combinations of disclosed elements may comprise separate embodiments. For example, one or more of the operations described above may be included in separate embodiments, or they may be included together in the same embodiment.

The descriptions above are intended to be illustrative, not limiting. Thus, it will be apparent to one skilled in the art that modifications may be made as described without departing from the scope of the claims set out below.

1. A method of characterizing features of an image, the method comprising:
accessing a template contour associated with the image;
comparing the template contour and an extracted contour of the image based on a plurality of distances between locations on the template contour and extracted contour points of the extracted contour, wherein the plurality of distances are weighted based on overlap of the locations on the template contour with a blocking structure in the image; and
based on the comparing, determining a matching geometry and/or a matching position of the template contour with a contour of the image.

2. The method of claim 1, wherein the plurality of distances is further weighted based on the locations on the template contour.

3. The method of claim 1, comprising determining the matching position and wherein the determining the matching position comprises placing the template contour in various locations on the image, and selecting the matching position from among the various locations based on the comparing.

4. The method of claim 1, comprising determining the matching geometry and wherein the determining the matching geometry comprises generating various geometries of the template contour on the image, and selecting the matching geometry from among the various geometries based on the comparing.

5. The method of claim 1, wherein the comparing comprises determining similarity between the template contour and the extracted contour points based on a combination of the weighted distances.

6. The method of claim 1, wherein the plurality of distances is further weighted based on a weight map associated with the template contour and/or a weight map associated with the blocking structure.

7. The method of claim 1, wherein a total weight for each of the plurality of weighted distances is determined by multiplying a weight associated with the template contour by a corresponding weight associated with the blocking structure.

8. The method of claim 7, wherein weights associated with the plurality of distances change based on positioning of the template contour relative to the image.

9. The method of claim 1, wherein the comparing comprises:
accessing blocking structure weights for locations on the blocking structure; and
determining a total weight for each location on the template contour based on the blocking structure weights and weights associated with corresponding locations on the contour that overlap with the blocking structure.

10. The method of claim 1, wherein the plurality of distances correspond to edge placement (EP) gauge lines normal to the template contour.

11. The method of claim 1, wherein the comparing comprises:
adjusting weights associated with corresponding locations on the template contour that overlap with the blocking structure; and
determining a total weight for each location on the contour based on the blocking structure weights and the adjusted weights associated with corresponding locations on the contour that overlap with the blocking structure.

12. The method of claim 11, wherein the adjusting the weights associated with the corresponding locations on the template contour that overlap with the blocking structure comprises updating a weight for a given position on the template contour based on at least one selected from: pixel values of the image, a location of the blocking structure in the image relative to the template contour, a previously identified structure located on the image, a location of the template contour, a relative position of the template contour with respect to the extracted contour points, or a combination selected therefrom.

13. The method of claim 1, wherein the determining a matching geometry or a matching position of the template contour relative to the extracted contour points comprises translation, scaling, and/or rotation of the template contour relative to the extracted contour points.

14. The method of claim 1, further comprising determining a metrology metric based on an adjusted geometry or position of the template contour relative to the extracted contour.

15. The method of claim 1, wherein the blocking structure comprises a portion of the image that represents a physical feature in a layer of a semiconductor structure, the physical feature blocking a view of a portion of a feature of interest in the image because of its location in the layer of the semiconductor structure relative to the feature of interest, the feature of interest being a feature from which the contour points are extracted.

16. The method of claim 1, wherein the comparing comprises accessing blocking structure weights for locations on the blocking structure, wherein the blocking structure weights follow a step function or a sigmoid function or user defined function, and wherein the blocking structure weights are determined based on an intensity profile of pixels in the image that form the blocking structure.

17. A non-transitory computer-readable medium having instructions therein, the instructions, when executed by a computer system, configured to cause to the computer system to at least:
access a template contour associated with an image;
compare the template contour and an extracted contour of the image based on a plurality of distances between locations on the template contour and extracted contour points of the extracted contour, wherein the plurality of distances are weighted based on overlap of the locations on the template contour with a blocking structure in the image; and
based on the comparison, determine a matching geometry and/or a matching position of the template contour with a contour of the image.

18. The medium of claim 17, wherein the blocking structure comprises a portion of the image that represents a physical feature in a layer of a semiconductor structure, the physical feature blocking a view of a portion of a feature of interest in the image because of its location in the layer of the semiconductor structure relative to the feature of interest, the feature of interest being a feature from which the contour points are extracted.

19. The medium of claim 17, wherein the plurality of distances is further weighted based on a weight map associated with the template contour and/or a weight map associated with the blocking structure.

20. A non-transitory computer-readable medium having instructions therein, the instructions, when executed by a computer system, configured to cause the computer system to at least:
access a template contour that corresponds to a set of contour points extracted from the image;
compare the template contour and the extracted contour points based on a plurality of distances between locations on the template contour and the extracted contour points, wherein the plurality of distances is adaptively weighted based on the locations on the template contour and whether the locations on the template contour overlap with blocking structures in the image, wherein the comparison comprises:
access to blocking structure weights for locations on the blocking structures;
determination of a total weight for each location on the contour based on the blocking structure weights and weights associated with corresponding locations on the contour that overlap with the blocking structures;
determination of a coarse similarity score based on a weighted sum of the plurality of distances multiplied by the total weights; and
repetition of the determination of the total weight and of the coarse similarity score for multiple geometries or positions of the template contour relative to the extracted contour points to determine an optimized coarse position of the template contour relative to the extracted contour points;
adjustment of the weights associated with the corresponding locations on the contour that overlap with the blocking structures;
determination of a total weight for each location on the contour based on the blocking structure weights and the adjusted weights associated with corresponding locations on the contour that overlap with the blocking structures;
determination of a first fine similarity score based on a weighted sum of the plurality of distances multiplied by the total weights;
determination of a second fine similarity score based on a weighted sum of the plurality of distances multiplied by the total weights only for unblocked locations on the contour that do not overlap with the blocking structures; and
repetition of the determination of the adjustment of the weights, determination of the total weight for each location on the contour based on the blocking structure weights and the adjusted weights, and the determination of the first and second fine similarities for multiple geometries or positions of the template contour relative to the extracted contour points to determine an optimized fine position of the template contour relative to the extracted contour points; and
based on the comparison, determine a matching geometry or a matching position of the template contour with the extracted contour points from the image.
